(19) United States
(12) Patent Application Publication
(10) Pub. No.: US 2015/0072172 A1
(43) Pub. Date: Mar. 12, 2015

(54) MICROPATTERN FORMATION METHOD, RELEASE METHOD, MAGNETIC RECORDING MEDIUM MANUFACTURING METHOD, MAGNETIC RECORDING MEDIUM, AND STAMPER MANUFACTURING METHOD

(71) Applicant: KABUSHIKI KAISHA TOSHIBA, Minato-ku (JP)

(72) Inventors: Kazutaka TAKIZAWA, Kawasaki-shi (JP); Kaori Kimura, Yokohama-shi (JP); Akihiko Takeo, Kokubunji-shi (JP)

(73) Assignee: KABUSHIKI KAISHA TOSHIBA, Minato-ku (JP)

(21) Appl. No.: 14/151,985

(22) Filed: Jan. 10, 2014

(30) Foreign Application Priority Data
Sep. 10, 2013 (JP) 2013-187570

(51) Int. Cl. G11B 5/855; G11B 5/74; G11B 5/84

(52) U.S. Cl. CPC G11B 5/855; G11B 5/8404; G11B 5/743
USPC 428/835.6; 216/42; 216/22; 427/333; 216/13; 205/68

(57) ABSTRACT

According to one embodiment, there is provided a pattern formation method including forming a target layer to be processed on a substrate, adding a second dispersion containing a polymer material including a polymer chain having a base metal at a terminal end and a second solvent to a first dispersion containing noble-metal microparticles and a first solvent, thereby preparing a noble-metal microparticle layer coating solution in which microparticles covered with the polymer material are dispersed, arranging the noble-metal microparticles covered with the polymer material on the target layer by using the noble-metal microparticle layer coating solution, and transferring a projections pattern of the noble-metal microparticles covered with the polymer material to the target layer.

### CROSS-REFERENCE TO RELATED APPLICATIONS

This application is based upon and claims the benefit of priority from Japanese Patent Application No. 2013-187570, filed Sep. 10, 2013, the entire contents of which are incorporated herein by reference.

### FIELD

Embodiments described herein relate generally to a micropattern formation method, release method, magnetic recording medium manufacturing method, magnetic recording medium, and stamper manufacturing method.

### BACKGROUND

Recently, as the amount of information significantly increases, strong demands have arisen for implementing a large-capacity information recording device. For example, element sizes of semiconductor memory devices are being extensively decreased in order to increase the capacity by increasing the packing density per unit area. Transistor wiring dimensions are being decreased within the range of a few nm to a few ten nm, so demands have arisen for implementing manufacturing techniques meeting this demand. Also, as hard disk drive (HDD) techniques, the development of various techniques such as perpendicular magnetic recording has been advanced to increase the density of a recording medium. In addition, a patterned medium has been proposed as a medium capable of further increasing the recording density and achieving a thermal decay resistance of medium magnetization at the same time.

The patterned medium records one or a plurality of magnetic regions as one cell. To record one-bit information in one cell, it is only necessary to magnetically isolate individual recording cells. Therefore, a general approach is to, e.g., isolate magnetic dot portions and nonmagnetic dot portions in the same plane by using the micropatterning techniques in the semiconductor manufacturing field. When forming a magnetic recording cell region as an independent projections pattern, it is only necessary to form a mask layer on a magnetic recording layer formed on a substrate beforehand, and transfer the projections pattern from above by using the mask layer. Alternatively, after a projections pattern is formed on a mask layer, a nonmagnetic region is formed by implanting ions irradiated with high energy into a desired region, thereby selectively isolating the pattern.

As described above, in order to increase the recording density, it is necessary to form the above-mentioned micropattern on a substrate, and form a mask corresponding to the pitch reduction of the projections pattern. An example of the existing techniques is a method using ultraviolet exposure or electron beam exposure. However, a micropatterning technique using metal microparticles is available as a method capable of simply forming micropatterns with smaller dimensional variations.

A metal microparticle is a general term for microparticles having a radius of a few nm to a few hundred nm, and is also called a nanoparticle or simply called a microparticle. When using metal microparticles on a substrate, the substrate is normally coated with a so-called dispersion in which the metal microparticle material is dispersed in a specific solvent, thereby obtaining a periodic pattern of the metal microparticles. Then, an independent projections pattern can be obtained on the same plane by using the metal microparticle coating film as a mask layer or underlayer. It is also possible to form physical projections on a substrate in advance, and form a desired pattern by using the projections as guides. Although microparticles are formed by various materials, microparticles using a noble-metal material are particularly chemically stable and have a high etching resistance. When using these microparticles as a projections pattern processing mask, it is possible to maintain the processing margin and reduce a dimensional conversion difference after processing.

Metal microparticles existing in a free space and dispersion readily aggregate by receiving interactions from surrounding metal microparticles due to the van der Waals force, so it is necessary to prevent this. Therefore, each metal microparticle has a protective group made of a polymer chain on its surface, and is physicochemically isolated from adjacent metal microparticles. This suppresses the aggregation of microparticles. In a micropatterning process using metal microparticles as masks, however, the protective group around each metal microparticle disappears due to plasma damage, so adjacent metal microparticles aggregate. Accordingly, a mask pattern changes on a substrate, and the dimensional variation of a transferred projections pattern worsens. In particular, the above-described noble-metal material has a high etching resistance, but also has a high van der Waals force that causes aggregation when compared to other microparticle materials. This makes it difficult to transfer narrow-pitch, narrow-spacing patterns.

On the other hand, metal microparticles remaining on a substrate form a residue in a manufacturing step, so it is desirable to remove these metal microparticles as soon as possible and improve the projections pattern flatness. That is, if microparticles remain on a target layer to be processed, unnecessary projections decrease the yield in a semiconductor manufacturing step, or projections formed by the particles deteriorate the head floating characteristic of a hard disk medium, and this worsens the HDI (Head Disk Interface) characteristic. Therefore, a technique of removing, i.e., releasing metal microparticles is necessary in addition to the metal microparticle material projections pattern processing technique.

The existing releasing processes include a method of physically removing a release material by exposing the material to a plasma ambient such as oxygen and processing the material, and a method of dissolving a release material by wet etching using a solution such as an acid or alkali. In dry etching, microparticles remaining after mask processing behave as a transfer mask, so a projections residue is produced on the substrate surface even after processing. By contrast, wet etching can reduce the residue on the substrate surface because microparticles themselves are dissolved, but has an essential problem that damages inflicted to the mask layer or substrate by an acid or alkali are unavoidable. Also, when using metal microparticles as described above, if the protective group inevitably disappears due to exposure to plasma or the like during the process, the metal microparticles are deactivated and hence do not affiliate with a dispersion medium such as an organic solvent. Since the metal microparticles cannot be released, it is difficult to reduce damages and remove projections at the same time.

In a process using a metal microparticle mask, therefore, it is desirable to establish a method of suppressing the aggregation of metal microparticles and a narrow spacing processing method, and enlarge the processing margin. Also, when releasing metal microparticles, it is necessary to reduce release defects from the substrate surface, and reduce damages to peripheral materials in wet release. However, when forming and releasing a metal microparticle mask pattern by applying the related art, the above-described problems arise, and uniform micropatterning is significantly difficult.

### BRIEF DESCRIPTION OF THE DRAWINGS

FIGS. 1A, 1B, 10, and 1D are views showing an example of a pattern formation method according to the first embodiment;

FIGS. 2A, 2B, 2C, 2D, and 2E are views showing another example of the pattern formation method according to the first embodiment;

FIGS. 3A, 3B, 3C, 3D, 3E, and 3F are views showing still another example of the pattern formation method according to the first embodiment;

FIGS. 4A, 4B, 4C, and 4D are views showing an example of a releasing method according to the second embodiment;

FIGS. 5A, 5B, 5C, and 5D are views showing another example of the release method according to the second embodiment;

FIGS. 6A, 6B, 6C, 6D, 6E, 6F, 6G, and 6H are views showing an example of a magnetic recording medium manufacturing method according to the third embodiment;

FIGS. 7A, 7B, 7C, 7D, 7E, 7F, 7G, 7H, and 7I are views for explaining another example of the magnetic recording medium manufacturing method according to the third embodiment;

FIGS. 8A, 8B, 8C, 8D, 8E, 8F, 8G, 8H, 8I, and 8J are views showing still another example of the magnetic recording medium manufacturing method according to the third embodiment;

FIGS. 9A, 9B, 9C, 9D, 9E, 9F, 9G, 9H, 9I, 9J, and 9K are views showing still another example of the magnetic recording medium manufacturing method according to the third embodiment;

FIGS. 10A, 10B, 10C, 10D, 10E, 10F, 10G, 10H, 10I, and 10J are views showing an example of a stamper manufacturing method according to the fourth embodiment;

FIGS. 11A, 11B, 11C, 11D, 11E, 11F, and 11G are views showing another example of a stamper manufacturing method according to the fourth embodiment;

FIGS. 12A, 12B, 12C, 12D, 12E, 12F, 12G, 12H, and 12I are views showing an example of nanoimprinting according to the fourth embodiment;

FIG. 13 is a view showing examples of a recording bit pattern in the circumferential direction of a magnetic recording medium;

FIG. 14 is a view showing another example of the recording bit pattern in the circumferential direction of a magnetic recording medium;

FIG. 15 is a partially exploded perspective view showing an example of a magnetic recording/reproduction apparatus to which the magnetic recording medium according to the embodiment is applicable;

FIG. 16 is a view showing an upper-surface SEM image of a metal microparticle mask according to the embodiment;

FIG. 17 is a view showing an upper-surface SEM image of a projections pattern formed by using the metal microparticle mask according to the embodiment;

FIG. 18 is another example of the view showing an upper-surface SEM image of a metal microparticle mask according to the embodiment; and

FIG. 19 is a view showing an upper-surface SEM image of a projections pattern after the metal microparticle mask according to the embodiment is released.

### DETAILED DESCRIPTION

Embodiments will be explained below.

A pattern formation method according to the first embodiment includes

forming a target layer to be processed on a substrate,

adding a second dispersion containing a polymer material including a polymer chain having a base metal at a terminal end and a second solvent to a first dispersion containing noble-metal microparticles and a first solvent, thereby preparing a noble-metal microparticle layer coating solution in which microparticles covered with the polymer material are dispersed,

arranging the noble-metal microparticles covered with the polymer material on the target layer by using the noble-metal microparticle layer coating solution, thereby forming a noble-metal microparticle layer, and

transferring a projections pattern based on the noble-metal microparticle layer to the target layer.

A release method according to the second embodiment includes

preparing a second dispersion containing a polymer material including a polymer chain having a base metal at a terminal end and a second solvent, and

applying the second dispersion to noble-metal microparticles arranged on a target layer to be processed, covering surfaces of the noble-metal microparticles with the polymer material, and affiliating the polymer chain with the surfaces of the noble-metal microparticles, thereby releasing the noble-metal microparticles from the target layer.

A magnetic recording medium manufacturing method according to the third embodiment is a method in which a mask layer and magnetic recording layer are applied as the above-mentioned layer to be processed, and includes

forming a magnetic recording layer on a substrate,

forming a mask layer on the magnetic recording layer,

adding a second dispersion containing a polymer material including a polymer chain having a base metal at a terminal end and a second solvent to a first dispersion containing noble-metal microparticles and a first solvent, thereby preparing a noble-metal microparticle layer coating solution in which the noble-metal microparticles covered with the polymer material are dispersed,

arranging the noble-metal microparticles covered with the polymer material on the mask layer by using the coating solution, thereby forming a noble-metal microparticle layer,

transferring a projections pattern based on the noble-metal microparticle layer to the mask layer, and

transferring the projections pattern to the magnetic recording layer.

Also, a stamper manufacturing method according to the fourth embodiment is a modification of the first and second embodiments, and includes

adding a second dispersion containing a polymer material including a polymer chain having a base metal at a terminal end and a second solvent to a first dispersion containing noble-metal microparticles and a first solvent, thereby preparing a noble-metal microparticle layer coating solution in which microparticles covered with the polymer material are dispersed,

arranging the noble-metal microparticles covered with the polymer material on a substrate by using the coating solution, thereby forming a noble-metal microparticle layer,

forming a conductive layer along a projections pattern based on the noble-metal microparticle layer,

forming an electroformed layer by performing electroplating by using the conductive layer as an electrode,

dipping the noble-metal microparticles covered with the polymer material between the substrate and the electroformed layer in the second dispersion as a release solution, covering surfaces of the noble-metal microparticles with a polymer material containing at least one type of a base metal and at least one type of sulfur, and affiliating the terminal-end polymer chain with the release solution, thereby releasing the electroformed layer from the substrate, and

removing a residue remaining on the electroformed layer.

In the first to fourth embodiments, the second solvent in which a polymer material containing a polymer chain having a base-metal material at the terminal end is dispersed is added to the first solvent in which noble-metal microparticles are dispersed. This makes it possible to cover the surface of the noble-metal microparticle with the shell of the terminal-end material of the polymer chain, thereby changing the surface activity. More specifically, the base-metal terminal end bonds to the noble-metal surface, or the base-metal terminal end bonds by substitution by a protective group of the noble-metal microparticle.

Since substitution to the base metal on the noble-metal surface decreases the net van der Waals force, aggregation occurs more hardly than when using only a noble metal. Accordingly, it is possible to relax and reduce the aggregation of metal microparticles in a processing step such as dry etching, and it is also possible to process a metal microparticle mask having a high etching resistance with a high dimensional accuracy and high definition. In addition, it is possible to enlarge the processing margin before aggregation occurs, and reduce dimensional variations in the manufacturing process. Also, the thickness of the shell containing the terminal-end material of the polymer chain is negligibly smaller than the diameter of the noble-metal microparticles. Consequently, the surface properties can be adjusted with almost no change in size of the metal microparticles.

Furthermore, the coating properties to the substrate surface can be improved by using a polymer soluble in a solvent having good coating properties. It is also possible to reduce a microparticle multilayered region because the ductility of the solvent improves during coating.

In the second and fourth embodiments, the second solvent in which a polymer material containing a polymer chain including a base metal is dispersed is used for noble-metal microparticles arranged on a substrate and layer to be processed, thereby releasing the noble-metal microparticles. When a protective group on the noble-metal microparticle surface modifies or disappears by dry etching or deposition, the affinity of the microparticles for the solvent significantly worsens. However, when the base-metal-containing polymer is bonded to the noble-metal surface again, the polymer chain at the other terminal end affiliates with the solvent, and this achieves good release from the substrate surface.

In the second embodiment, the flatness can be improved by reducing the unreleased residue on the substrate. In addition, damages to the substrate and mask material can be reduced by using an organic solvent in place of an acid or alkali solution conventionally used to dissolve microparticles and a liftoff layer. Also, in the fourth embodiment, the electroformed layer, i.e., the stamper is released from the substrate by using the microparticle layer formed on the substrate as a liftoff layer. In this process, if the stamper is physically released from the substrate by applying an external force, the stamper is strained, and the in-plane flatness deteriorates. In the embodiment, however, the microparticle layer is released by using the organic solvent. Accordingly, the stamper is not strained, and damages to the projections pattern can be reduced.

In the first to fourth embodiments, the noble-metal microparticle material can be selected from, e.g., Au, Ag, Pt, Pd, Ru, Ir, and Rh.

The surface of each noble-metal microparticle is modified with a protective group made of a polymer chain. The surfaces of adjacent noble-metal microparticles are covered with at least one type of a base metal, and the microparticles are physicochemically separated by the polymer chain bonded to the base metal.

Note that a base metal is a material opposite to a noble metal. In this specification, however, base metals are materials described in the periodic table except for the above-mentioned noble metals, and these materials will be represented as base metals in the explanation of manufacturing steps for the sake of convenience. Examples of the base metal are an alkali metal, alkali-earth metal, transition metal, nonmetal, halogen, alloys thereof, and compounds thereof. In addition, the base metal includes a functional group of an organic polymer.

As the base metal, sulfur, silicon, and chlorine can be used.

The base metal is contained in the terminal end of the polymer chain, and adsorbed to the surface of the noble metal by adding a polymer in the solvent.

The first solvent is a dispersion medium of noble-metal microparticles, and selected from various organic solvents. Also, the second solvent can be compatible with the first solvent. The solubility parameter of each solvent can be as small as possible, and can be set at 6.0 or less. The first and second solvents can be the same. If the solubility parameter exceeds 6.0, the first and second solvents are not dissolved but separated, and often aggregate dispersed microparticles.

The first and second solvents are selected from materials that do not dissolve the protective group of the contained metal microparticles, and do not aggregate other microparticles when added.

The concentration of the noble-metal microparticles can be changed in accordance with the area of a substrate to be coated, or the number of metal microparticle layers to be formed. Also, a polymer solution containing base-metal microparticles largely changes the wettability of the noble-metal microparticle dispersion in accordance with the addition amount, and hence has an optimum range. More specifically, the concentration of the polymer with respect to the second solvent can be set at 0.01 to 2 wt % for the following reasons. If the concentration is lower than 0.01 wt %, the wettability of the dispersion decreases, and a defective region, i.e., a so-called 0-layer region is formed in the film. If the concentration is higher than 2 wt %, a metal microparticle multilayered structure is locally formed in the substrate.

When the noble-metal microparticle surfaces are modified by the addition of the base-metal microparticles/polymer solution, a shell made of the base-metal material is formed on the noble-metal microparticle surface. This shell is formed by adsorption at the polymer terminal end, and has an extremely small thickness, more specifically, a thickness of 1 nm or less. Accordingly, the surface properties can be adjusted with almost no change in distance between the noble-metal microparticles.

The embodiments will be explained in more detail below with reference to the accompanying drawings.

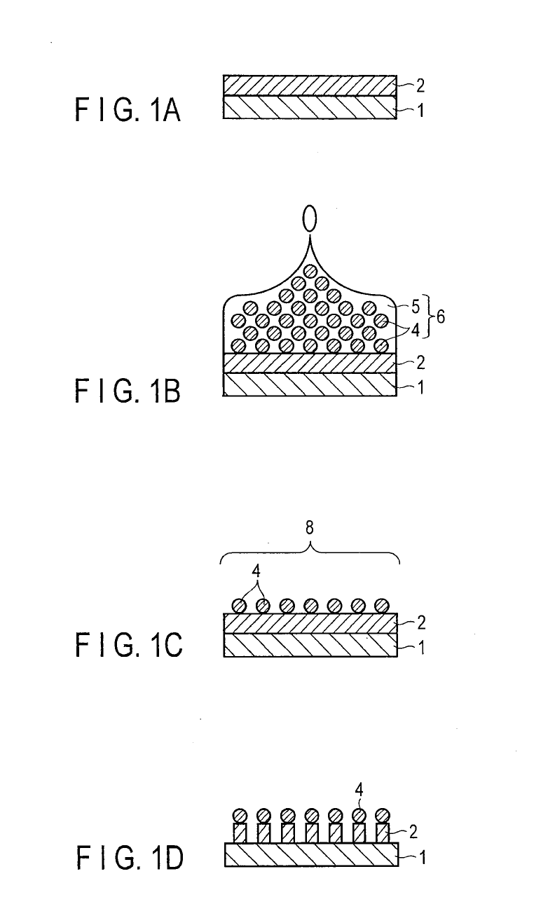

FIGS. 1A, 1B, 1C, and 1D are exemplary views showing an example of the pattern formation method according to the first embodiment.

First, as shown in FIG. 1A, a layer 2 to be processed is formed on a substrate 1.

Then, as shown in FIG. 1B, a metal microparticle solution 6 containing metal microparticles 4, the first solvent, the second solvent soluble in the first solvent, and a solution 5 containing a polymer material is dropped on the layer 2 to be processed, thereby forming a coating film.

The metal microparticle solution is prepared by adding the second solvent containing a polymer including sulfur or a base metal at the terminal end to a dispersion containing noble-metal microparticles and the first solvent. The noble-metal microparticle surface is covered with sulfur or the base metal, and has a polymer chain (not shown).

Subsequently, as shown in FIG. 1C, the layer 2 to be processed is coated with a monolayer of the microparticles 4, thereby forming a microparticle mask layer 8. The “monolayer” herein mentioned means a state in which the microparticles 4 are arranged into a single layer on an underlayer such as the layer 2 to be processed.

Subsequently, as shown in FIG. 1D, a projections pattern is transferred by etching to the layer 2 to be processed by using the microparticles 4 as masks. Consequently, a projections micropattern of the metal microparticles 4 is obtained.

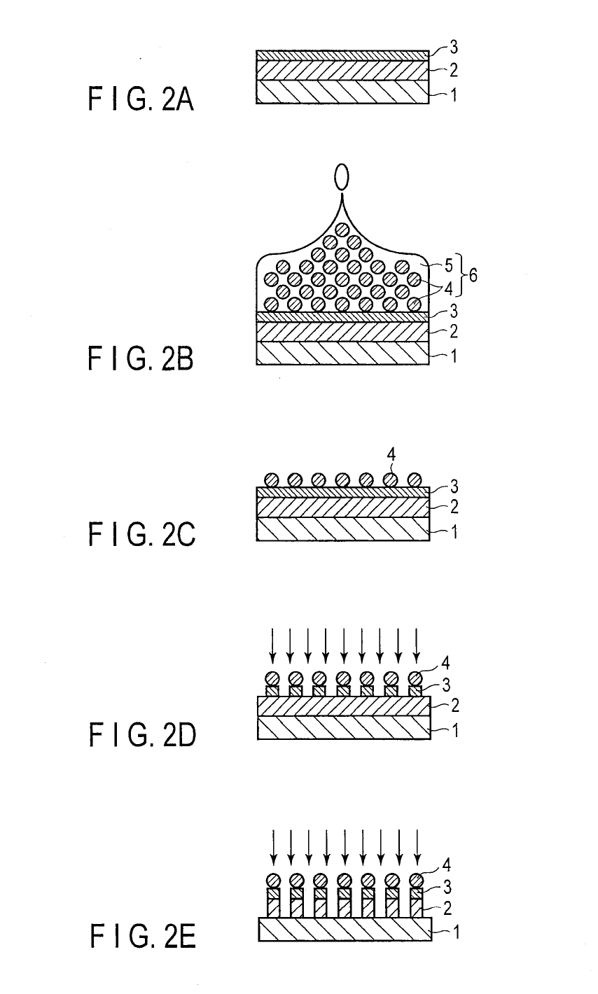

FIGS. 2A, 2B, 2C, 2D, and 2E are exemplary views showing another example of the pattern formation method according to the first embodiment.

This embodiment is an example in which a transfer layer for improving the projections pattern transfer properties is formed on a target layer to be processed.

First, as shown in FIG. 2A, a layer 2 to be processed and transfer layer 3 are formed on a substrate 1.

Then, as shown in FIG. 2B, a metal microparticle layer coating solution 6 is dropped on the transfer layer 3. The metal microparticle layer coating solution 6 is the same as that used in the first embodiment.

Subsequently, as shown in FIG. 2C, the transfer layer 3 is coated with a monolayer of microparticles 4.

Furthermore, as shown in FIG. 2D, a metal microparticle pattern is transferred to the transfer layer 3 by etching.

Subsequently, as shown in FIG. 2E, the projections pattern is transferred by etching to the layer 2 to be processed by using the transfer layers 3 and metal microparticles 4 as masks.

Consequently, projections pattern processing can be performed on the layer 2 to be processed.

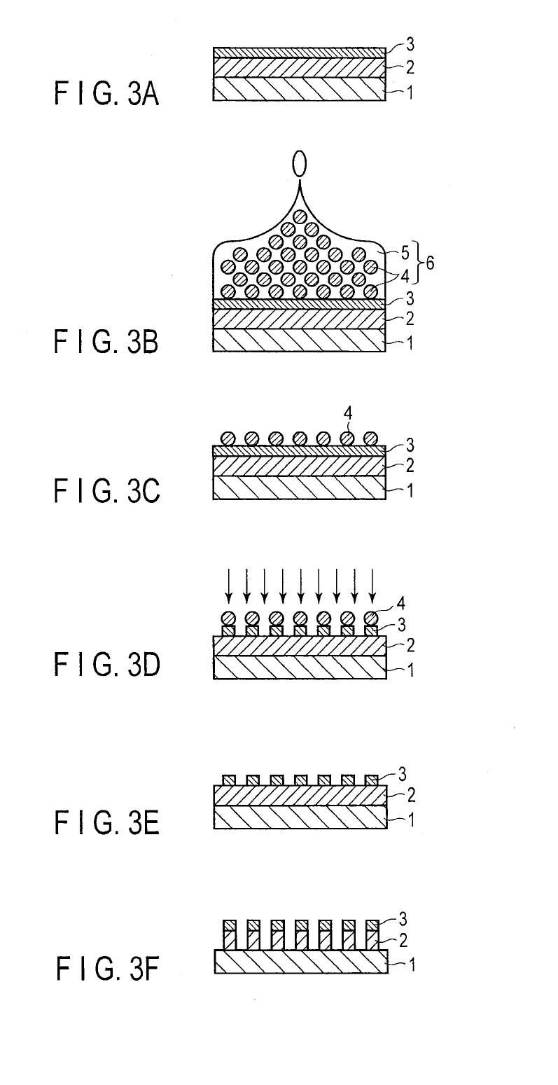

FIGS. 3A, 3B, 3C, 3D, 3E, and 3F are exemplary views showing still another example of the pattern formation method according to the first embodiment.

This embodiment includes a step of removing metal microparticles 4 from a substrate after a projections pattern of the microparticles 4 is transferred to a transfer layer 3.

First, as shown in FIG. 3A, a layer 2 to be processed and transfer layer 3 are formed on a substrate 1.

Then, as shown in FIG. 3B, a metal microparticle solution 6 is dropped on the transfer layer 3. The metal microparticle solution 6 is the same as that used in the first embodiment.

Subsequently, as shown in FIG. 3C, the transfer layer 3 is coated with a monolayer of microparticles 4.

Furthermore, as shown in FIG. 3D, a metal microparticle pattern is transferred to the transfer layer 3 by etching.

Then, as shown in FIG. 3E, the microparticles are removed from the transfer layers 3. In this step, the removal of the microparticles 4 is performed by a method capable of reducing damages to the transfer layers 3 and substrate 1.

Finally, as shown in FIG. 3F, the projections pattern is transferred by etching to the layer 2 to be processed by using the transfer layers 3 as masks.

Consequently, projections pattern processing can be performed on the layer 2 to be processed. As will be described later, the metal microparticles 4 often aggregate by dry etching. Therefore, the deterioration of the pattern transfer properties caused by subsequent dry etching can be reduced by removing the metal microparticles 4 from the surfaces of the transfer layers 3.

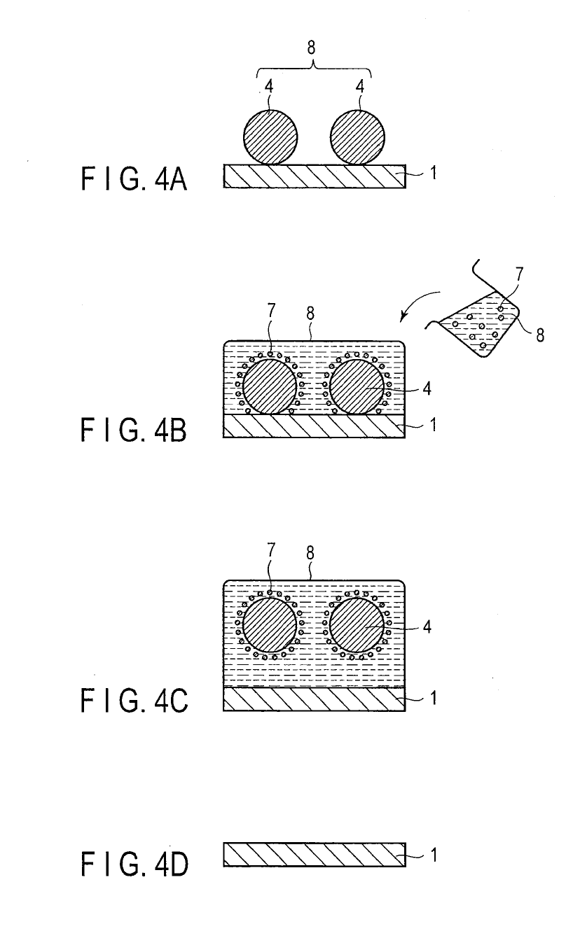

FIGS. 4A, 4B, and 4C are exemplary views for explaining an example of a release method according to the second embodiment.

This embodiment discloses a method of releasing metal microparticles from an underlayer such as a substrate, and is also applicable to liftoff or the like.

As shown in FIG. 4A, when protective groups on the surfaces of metal microparticles 4 are removed by dry etching or deposition, the activity of the metal microparticles 4 with respect to a solvent decreases.

As shown in FIG. 4B, therefore, the substrate is dipped in a second solvent 8, as a release solution, which contains a polymer including a base metal 7 at the terminal end with respect to the surface of the metal microparticle 4. The base metal 7 at the terminal end bonds to the surfaces of the noble-metal microparticles 4, and the microparticles 4 are readily removed from the substrate because the polymer chain at the other end affiliates with the solvent 8. Accordingly, the metal microparticles 4 are released from the substrate 1 when it is dipped in the solvent.

Finally, as shown in FIG. 4D, the substrate 1 is cleaned by a method such as washing, thereby obtaining a cleaned surface from which the metal microparticles 4 are removed.

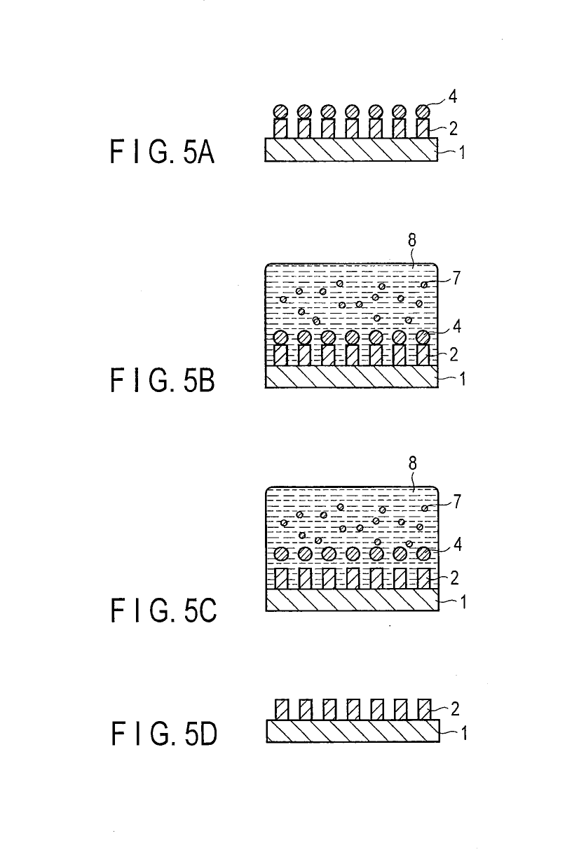

FIGS. 5A, 5B, 5C, and 5D are exemplary views for explaining another example of the release method according to the second embodiment.

This embodiment discloses a method of removing only metal microparticles after a projections pattern is formed on a target layer to be processed on a substrate by the method of the first embodiment.

As shown in FIG. 5A, when dry etching is performed by using metal microparticles 4 as masks, the metal microparticles 4 are deactivated because the protective groups around the metal microparticles 4 are decomposed.

As shown in FIG. 5B, therefore, a substrate 1 is dipped in a second solvent 8, as a release solution, which contains a polymer having a base metal 7 at the terminal end. Consequently, the base metal 7 bonds to the surfaces of the noble-metal microparticles 4 and covers the noble metal.

Furthermore, as shown in FIG. 5C, the polymer chain at the other end of the base metal 7 affiliates with the solvent 8, so the metal microparticles 4 are released from a layer 2 to be processed, and dispersed in the solvent 8.

Finally, as shown in FIG. 5D, a clean projections pattern of the layer 2 to be processed formed on the substrate 1 is obtained by a method such as washing.

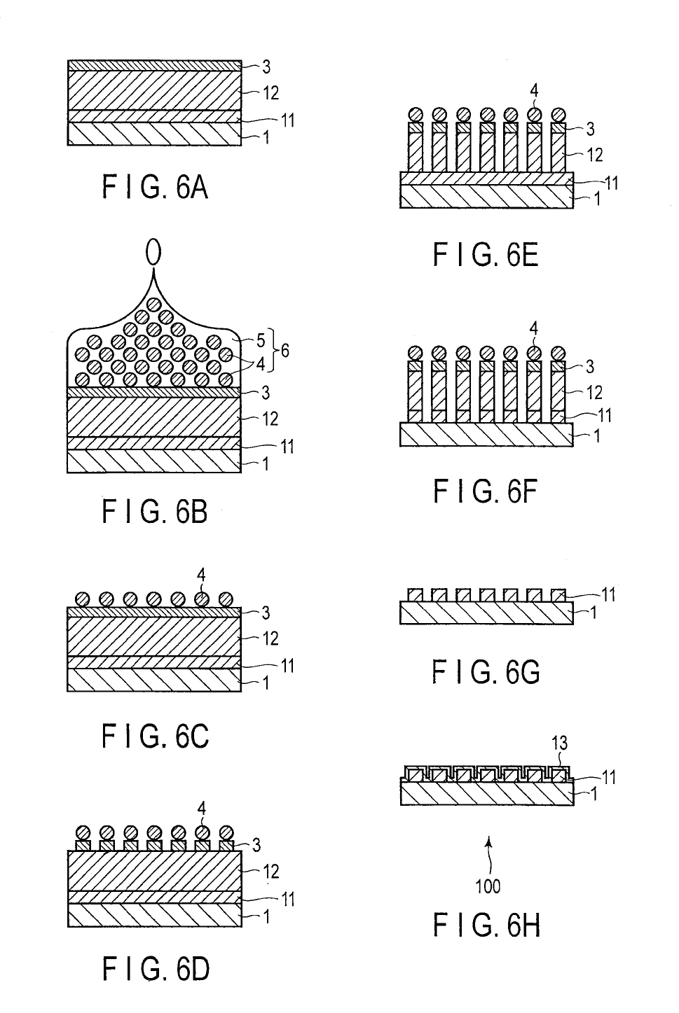

FIGS. 6A, 6B, 6C, 6D, 6E, 6F, 6G, and 6H are exemplary views showing an example of a magnetic recording medium manufacturing method according to the third embodiment.

As shown in FIG. 6A, a magnetic recording layer 11, mask layer 12, and transfer layer 3 are sequentially formed on a substrate 1. In this embodiment, the magnetic recording layer 11 is the layer 2 to be processed in the first embodiment.

Then, as shown in FIG. 6B, a metal microparticle solution is dropped on the transfer layer 3.

Then, as shown in FIG. 6C, the transfer layer 3 is coated with a monolayer of microparticles 4.

Subsequently, as shown in FIG. 6D, a projections pattern is transferred to the transfer layer 3 by etching by using the microparticles 4 as masks.

Subsequently, as shown in FIG. 6E, the projections pattern is transferred to the mask layer by etching.

Furthermore, as shown in FIG. 6F, the projections pattern is transferred to the magnetic recording layer by etching.

Then, as shown in FIG. 6G, an upper layer portion including the mask layer 12 is removed from the magnetic recording layer 11.

Finally, as shown in FIG. 6H, a protective film 13 is formed on the magnetic recording layer 11. As a consequence, a magnetic recording medium 100 can be obtained.

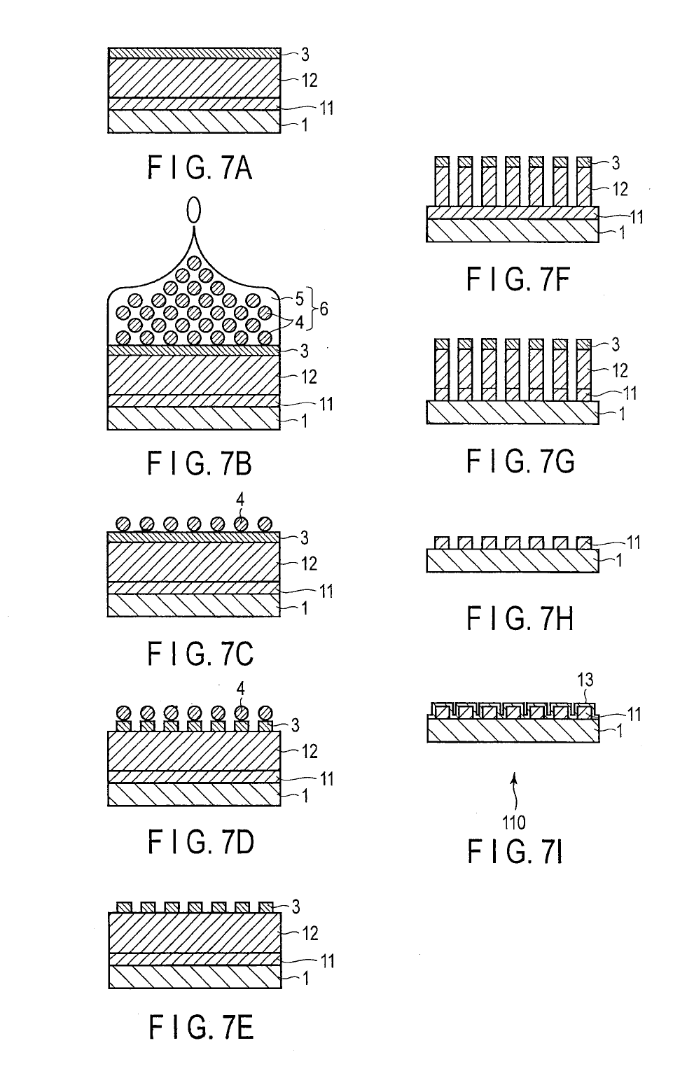

FIGS. 7A, 7B, 7C, 7D, 7E, 7F, 7G, 7H, and 7I are exemplary views showing another example of the magnetic recording medium manufacturing method according to the third embodiment.

As shown in FIGS. 7A, 7B, 7C, 7D, 7E, 7F, 7G, 7H, and 7I, a magnetic recording medium 110 can be obtained by the same method as that shown in FIGS. 6A, 6B, 6C, 6D, 6E, 6F, 6G, and 6H, except that a magnetic recording layer 11 is used instead of the layer 2 to be processed, and there is a step of removing metal microparticles 4 from a transfer layer 3 as shown in FIG. 7E after a projections pattern is transferred to the transfer layer 3 as shown in FIG. 7D.

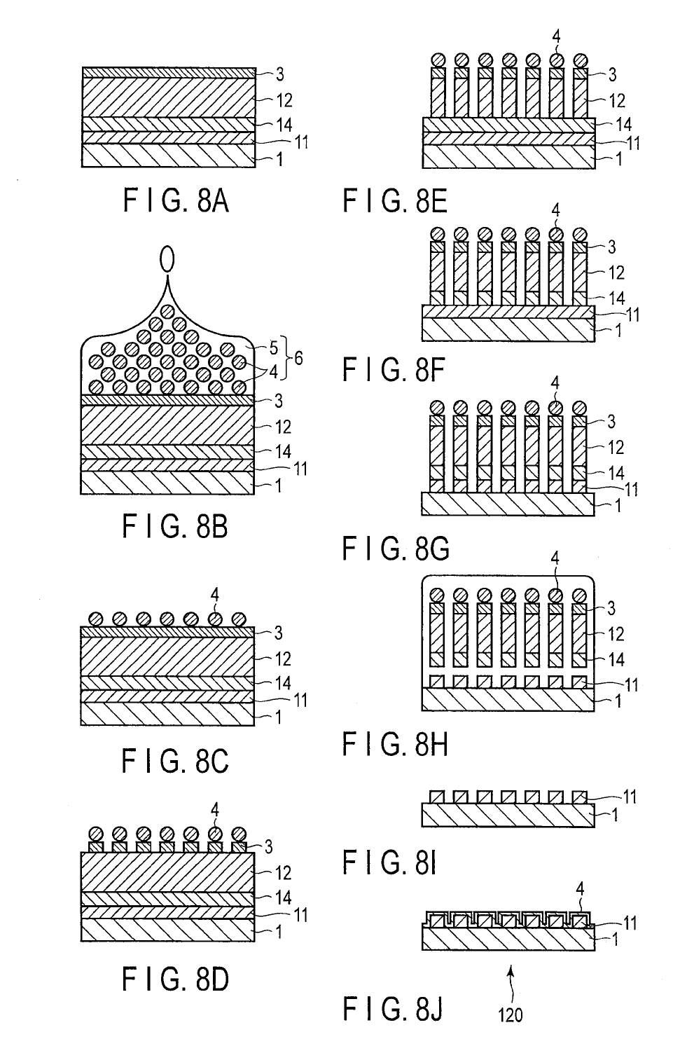

FIGS. 8A, 8B, 8C, 8D, 8E, 8F, 8G, 8H, 8I, and 8J are exemplary views showing still another example of the magnetic recording medium manufacturing method according to the third embodiment.

As shown in FIGS. 8A, 8B, 8C, 8D, 8E, 8F, 8G, 8H, 8I, and 8J, a magnetic recording medium 120 can be obtained by the same method as that shown in FIGS. 6A, 6B, 6C, 6D, 6E, 6F, 6G, and 6H, except that a magnetic recording layer 11 is used instead of the layer 2 to be processed, a release layer 14 is formed between the magnetic recording layer 11 and a mask layer 12, a projections pattern is transferred from the mask layer 12 to the release layer 14 as shown in FIG. 8F, and there is a step of lifting off the mask layer 12 by dissolving the release layer 14 after the projections pattern is transferred to the magnetic recording layer 11 as shown in FIG. 8H.

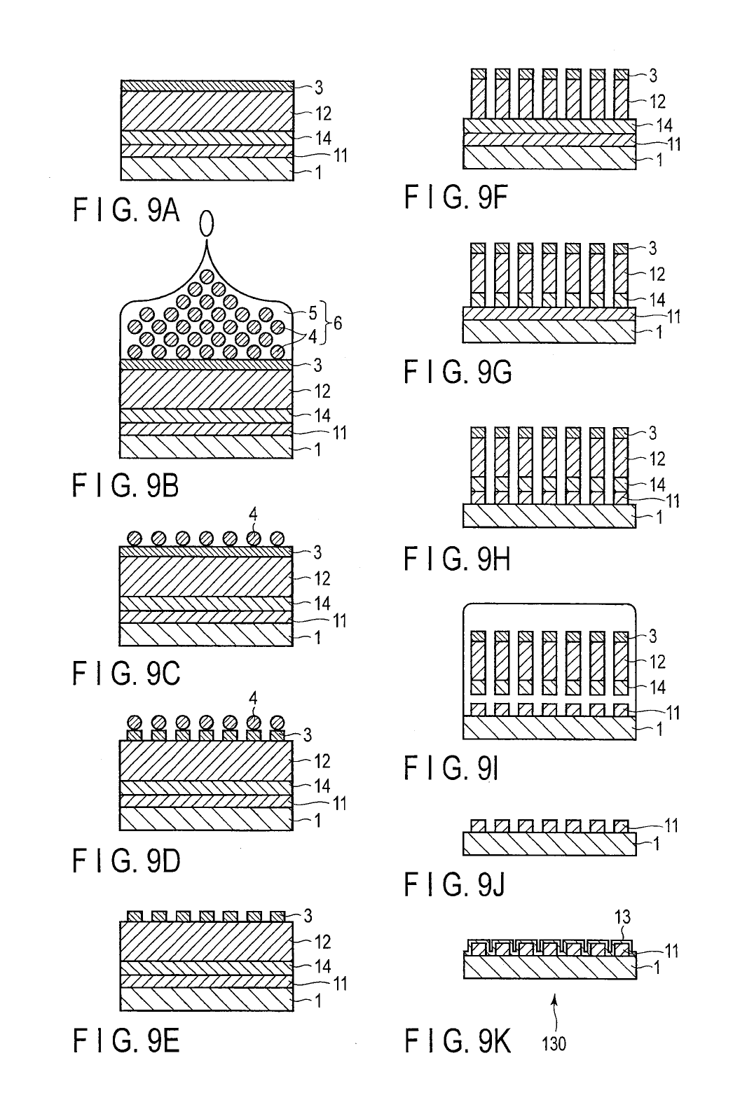

FIGS. 9A, 9B, 9C, 9D, 9E, 9F, 9G, 9H, 9I, 9J, and 9K are exemplary views showing still another example of the magnetic recording medium manufacturing method according to the third embodiment.

As shown in FIGS. 9A, 9B, 9C, 9D, 9E, 9F, 9G, 9H, 9I, 9J, and 9K, a magnetic recording medium 130 can be obtained by the same method as that shown in FIGS. 7A, 7B, 7C, 7D, 7E, 7F, 7G, 7H, and 7I, except that a magnetic recording layer is used instead of the target layer, a release layer is formed between the magnetic recording layer and a mask layer, a projections pattern is transferred from the mask layer to the release layer as shown in FIG. 9G, and there is a step of lifting off the mask layer by dissolving the release layer after the projections pattern is transferred to the magnetic recording layer as shown in FIG. 9I.

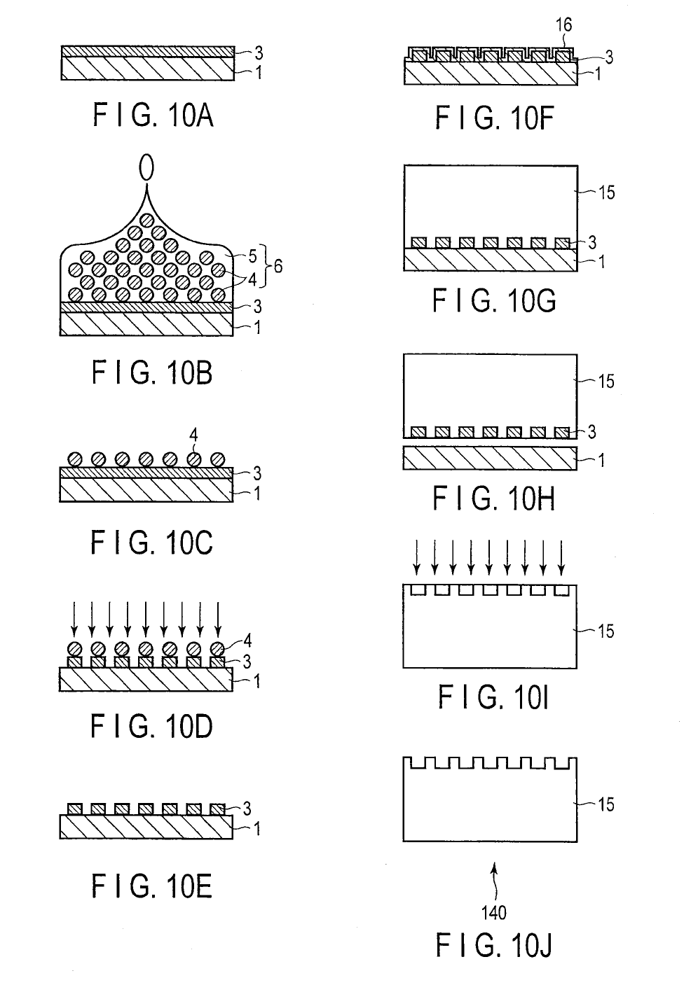

FIGS. 10A, 10B, 10C, 10D, 10E, 10F, 10G, 10H, 10I, and 10J are exemplary views showing an example of a stamper manufacturing method according to the fourth embodiment.

This embodiment discloses a method of manufacturing a stamper by using a projections pattern formed by arranging metal microparticles by applying a metal microparticle solution 6 on a transfer layer, and transferred by etching, based on the method of the first embodiment.

First, as shown in FIG. 10A, a transfer layer 3 is formed on a substrate 1.

Then, as shown in FIG. 10B, a metal microparticle solution 6 containing metal microparticles 4 and a solvent 5 on the transfer layer 3.

Then, as shown in FIG. 10C, the transfer layer 3 is coated with a monolayer of the microparticles 4.

Furthermore, as shown in FIG. 10D, a projections pattern is transferred to the transfer layer 3 by etching by using the microparticles 4 as masks.

Subsequently, as shown in FIG. 10E, the metal microparticles 4 are removed from the transfer layers 3.

Subsequently, as shown in FIG. 10F, the projections pattern surfaces of the transfer layers are covered with a conductive layer.

Subsequently, as shown in FIG. 10G, electroforming is performed through a conductive layer 16, thereby forming an electroformed layer 15 having the projections pattern.

Since the electroformed layer 15 is connected to the transfer layers 3 and substrate 1 via the conductive layer 16, the electroformed layer 15 is released from the substrate 1, as shown in FIG. 10H.

Furthermore, as shown in FIG. 10I, the projections pattern surface of the released electroformed layer 15 contains the transfer layers 3 as residues, so the transfer layers 3 are removed by etching.

Finally, as shown in FIG. 10J, a stamper 140 is obtained by cleaning the projections pattern surface by washing.

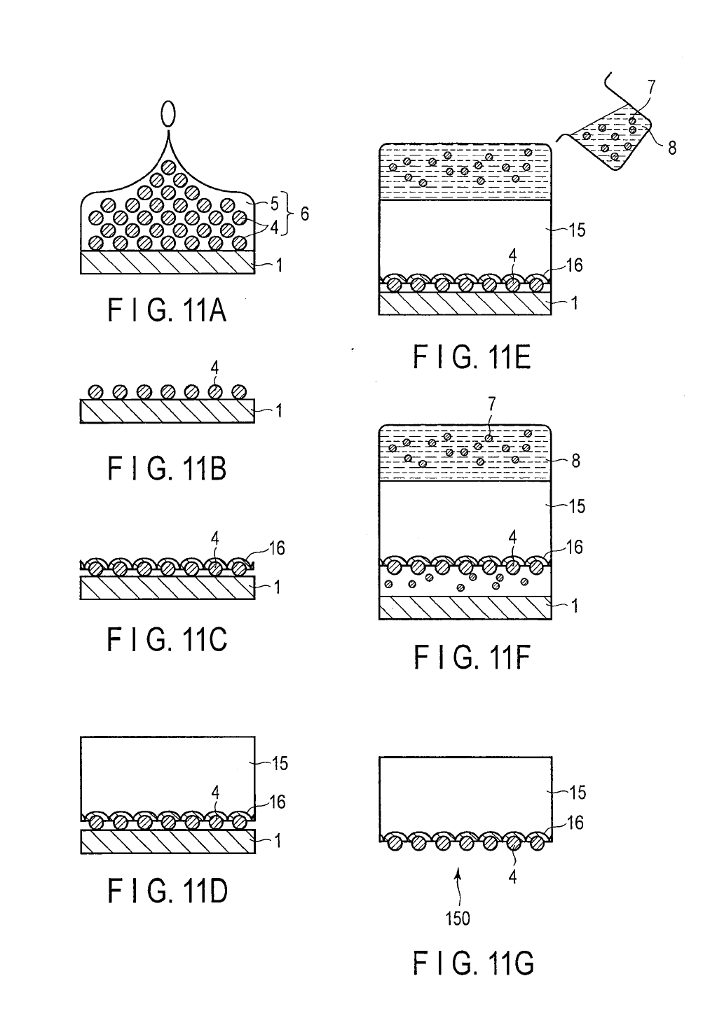

FIGS. 11A, 11B, 11C, 11D, 11E, 11F, 11G, 11H, and 11I are exemplary views showing another example of the stamper manufacturing method according to the fourth embodiment.

In this embodiment, as shown in FIGS. 11A, 11B, 11C, 11D, 11E, 11F, 11G, 11H, and 11I, a metal microparticle pattern is formed as a projections pattern, and used as a liftoff layer after electroforming.

First, as shown in FIG. 11A, a metal microparticle solution 6 is dropped on a substrate 1.

Then, as shown in FIG. 11B, the substrate 1 is coated with a monolayer of microparticles 4.

Then, as shown in FIG. 11C, the surface is covered by forming a conductive layer 16 on the microparticles 4. In this step, the conductive layer 16 does not completely fill the spacings between the metal microparticles 4 having a micropattern, but covers the upper portions of the metal microparticles 4, and forms a continuous film.

Subsequently, as shown in FIG. 11D, electroforming is performed through the conductive layer 16, thereby forming an electroformed layer 15 having a projections pattern.

Then, as shown in FIG. 11E, the substrate and electroformed layer 15 are dipped in a second solvent, as a release solution, which contains a polymer having a base metal at the terminal end. As in the second embodiment, the surfaces of the metal microparticles 4 are covered with the base metal, and the polymer chain affiliates with the solvent. As shown in FIG. 11F, therefore, the electroformed layer 15 containing the metal microparticles 4 is readily released from the substrate 1.

Finally, as shown in FIG. 11G, a clean stamper 150 is obtained by washing the projections pattern and electroformed layer 15. In this embodiment, no unnecessary stress is applied to the stamper when the electroformed layer 15 is released, so a stamper having a small in-plane strain and high uniformity can be manufactured.

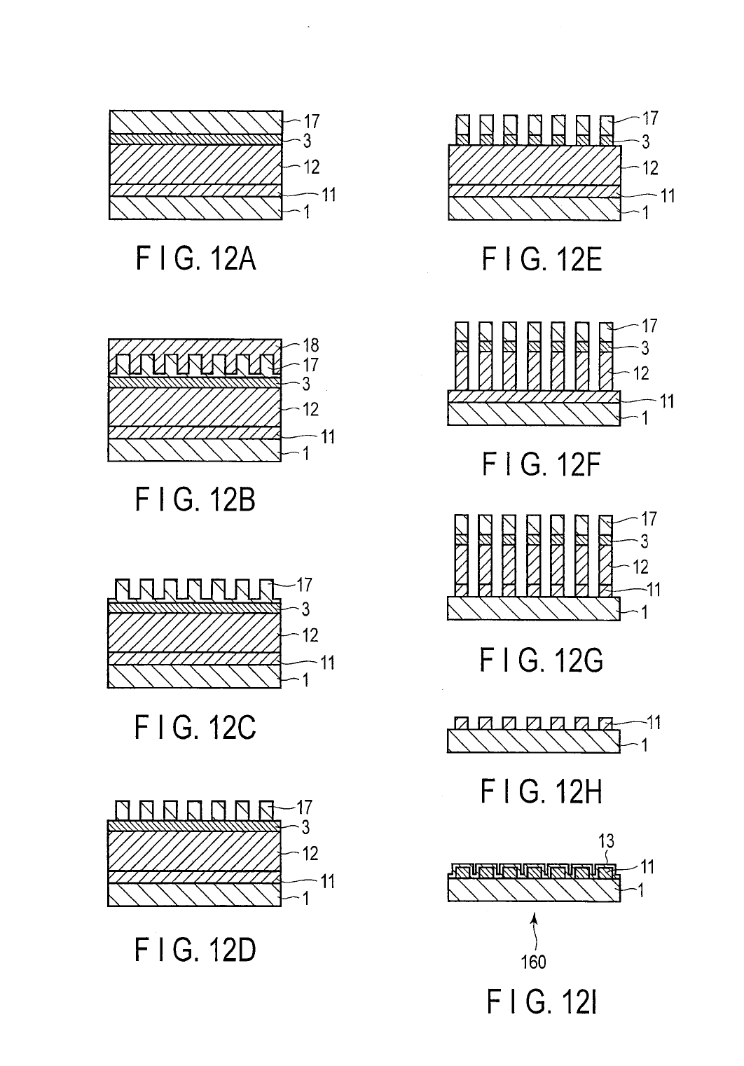

FIGS. 12A, 12B, 12C, 12D, 12E, 12F, 12G, 12H, and 12I are views showing an example of a magnetic recording medium manufacturing method using the stamper according to the fourth embodiment.

This embodiment discloses a method of manufacturing a magnetic recording medium by nanoimprinting using the manufactured stamper.

First, as shown in FIG. 12A, a magnetic recording layer 11, mask layer 12, transfer layer 3, and imprint resist layer 17 are formed on a substrate 1.

Then, as shown in FIG. 12B, the imprint resist layer 17 is fluidized by pressing the stamper against it, thereby forming a projections pattern. In this step, the imprint resist is solidified by applying energy when the stamper is pressed.

Then, as shown in FIG. 12C, the stamper is released from the projections pattern of the imprint resist layers 17.

After the stamper is released, a residue is formed between the imprint resist layers 17 and transfer layer. Therefore, the residue is removed by dry etching as shown in FIG. 12D.

Subsequently, as shown in FIG. 12E, the projections pattern is transferred to the transfer layer 3 by using the imprint resist layers 17 as masks.

Subsequently, as shown in FIG. 12F, the projections pattern is transferred to the mask layer 12.

Subsequently, as shown in FIG. 12G, the projections pattern is transferred to the magnetic recording layer 11.

Furthermore, as shown in FIG. 12H, an upper layer portion including the mask layers 12 is removed from the magnetic recording layers 11.

Finally, as shown in FIG. 12I, a protective film is formed on the magnetic recording layers. Thus, a magnetic recording medium 160 can be obtained.

### Layer to be Processed Formation Step

First, a target layer to be processed is formed on a substrate. The target layer is a layer to which a metal microparticle projections pattern (to be described later) is transferred. The metal microparticle projections pattern can be transferred directly to the target layer, but a mask layer can be formed between the target layer and a metal microparticle layer in order to improve the transfer accuracy.

Although the shape of the substrate is not limited at all, the substrate is normally circular and made of a hard material. Examples are a glass substrate, metal-containing substrate, carbon substrate, and ceramics substrate. To improve the pattern in-plane uniformity, the roughness of the substrate surface is desirably decreased. It is also possible to form a protective film such as an oxide film on the substrate surface as needed.

As the glass substrate, it is possible to use amorphous glass such as soda lime glass or aluminosilicate glass, or crystallized glass such as lithium-based glass. Furthermore, a sintered substrate mainly containing alumina, aluminum nitride, or silicon nitride can be used as the ceramics substrate.

The target layer can be formed on the substrate by various methods. For example, the target layer can be formed by PVD (Physical Vapor Deposition) such as vacuum deposition, electron beam deposition, molecular beam deposition, ion beam deposition, ion plating, and sputtering, and CVD (Chemical Vapor Deposition) using heat, light, and plasma. Also, in these physical and chemical vapor deposition methods, the thickness of the target layer can be adjusted by properly changing parameters such as the process gas pressure, gas flow rate, substrate temperature, input power, chamber ambient, and deposition time.

The target layer is selected from various materials in accordance with the application. More specifically, the target layer is selected from the group consisting of Al, C, Si, Ti, V, Cr, Mn, Co, Ni, Cu, Fe, Zn, Ga, Zr, Nb, Mo, Ru, Pd, Ag, Au, Hf, Ta, W, Ir, and Pt, and can be made of alloys and compounds thereof. An alloy is made of at least two types of materials selected from the above group. Also, a compound is selected from, e.g., an oxide, nitride, boride, and carbide. In this case, it is possible to select the material of a metal microparticle film to be formed on the target layer and a mask layer material capable ensuring an etching selectivity to projections pattern dimensions, and appropriately determine the film thickness.

On the other hand, this layer to be processed is equivalent to a magnetic recording layer in the manufacture of a magnetic recording medium. Therefore, a magnetic recording medium having a physically and magnetically isolated projections structure is obtained by transferring projections of the metal microparticle layer to the magnetic recording layer.

The magnetic recording layer is deposited on the substrate as described previously. In addition, a soft under layer (SUL) having a high magnetic permeability can be formed between the substrate and magnetic recording layer. The soft under layer returns a recording magnetic field from a magnetic head for magnetizing the perpendicular magnetic recording layer, i.e., performs a part of the magnetic head function. The soft under layer can apply a sufficient steep perpendicular magnetic field to the magnetic field recording layer, thereby increasing the recording/reproduction efficiency.

Materials containing, e.g., Fe, Ni, and Co can be used as the soft under layer. Among these materials, it is possible to use an amorphous material having none of magnetocrystalline anisotropy, a crystal defect, and a grain boundary, and showing a high soft magnetism. The soft amorphous material can reduce the noise of the recording medium. An example of the soft amorphous material is a Co alloy mainly containing Co and also containing at least one of Zr, Nb, Hf, Ti, and Ta. For example, it is possible to select CoZr, CoZrNb, and CoZrTa.

In addition, an underlayer for improving the adhesion of the soft under layer can be formed between the soft under layer and substrate. As the underlayer material, it is possible to use at least one material selected from, e.g., Ni, Ti, Ta, W, Cr, Pt, and alloys, oxides, and nitrides of these elements. For example, it is possible to use NiTa and NiCr as the underlayer material. Note that the underlayer can include multiple layers.

Furthermore, an interlayer made of a nonmagnetic metal material can be formed between the soft under layer and perpendicular magnetic recording layer. The interlayer has two functions: one is to interrupt the exchange coupling interaction between the soft under layer and perpendicular magnetic recording layer; and the other is to control the crystallinity of the perpendicular magnetic recording layer. The interlayer material can be selected from Ru, Pt, Pd, W, Ti, Ta, Cr, Si, and alloys, oxides, and nitrides of these elements.

The perpendicular magnetic recording layer mainly contains Co, also contains at least Pt, and can further contain a metal oxide. In addition to Co and Pt, the perpendicular magnetic recording layer can also contain one or more elements selected from B, Ta, Mo, Cu, Nd, W, Nb, Sm, Tb, and Ru. When these elements are contained, it is possible to promote downsizing of magnetic grains, and improve the crystallinity and orientation, thereby obtaining recording/reproduction characteristics and thermal decay characteristics for a high recording density. Practical examples of the material usable as the perpendicular magnetic recording layer are alloys such as a CoPt-based alloy, a CoCr-based alloy, a CoCrPt-based alloy, CoPtO, CoPtCrO, CoPtSi, CoPtCrSi, and CoCrSiO₂.

The thickness of the perpendicular magnetic recording layer can be set to 1.0 nm or more in order to measure a reproduced output signal with high accuracy, and can be set to 40 nm or less in order to suppress the distortion of the signal intensity. If the thickness is smaller than 1.0 nm, the reproduced output is extremely low, and the noise component becomes dominant. On the other hand, if the thickness is larger than 40 nm, the reproduced output becomes excessive, and the signal waveform is distorted.

A protective layer can be formed on the perpendicular magnetic recording layer. The protective layer has the effect of preventing corrosion and deterioration of the perpendicular magnetic recording layer, and preventing damage to the medium surface when a magnetic head comes in contact with the recording medium. Examples of the protective layer material are materials containing C, Pd, SiO₂, and ZrO₂. Carbon can be classified into sp²-bonded carbon (graphite) and sp³-bonded carbon (diamond). Sp³-bonded carbon is superior in durability and corrosion resistance, and sp²-bonded carbon is superior in flatness. Carbon is normally deposited by sputtering using a graphite target, and amorphous carbon containing both sp²-bonded carbon and sp³-bonded carbon is deposited. Carbon in which the ratio of sp³-bonded carbon is high is called diamond-like carbon (DLC). DLC is superior in durability, corrosion resistance, and flatness, and usable as the protective layer of the magnetic recording layer.

Furthermore, a lubricating layer can be formed on the protective layer. Examples of a lubricant used in the lubricating layer are perfluoropolyether, alcohol fluoride, and fluorinated carboxylic acid.

A release layer can be formed on the target layer and magnetic recording layer. After a projections pattern is transferred to the target layer or magnetic recording layer, it is possible to apply a liftoff process of releasing the mask layer by removing the release layer. This release layer desirably has a high etching rate and a high dissolution rate with respect to a release solution.

### Mask Layer Formation Step

A mask layer for transferring a projections pattern is formed on the target layer and magnetic recording layer.

The mask layer is a layer to which the metal microparticle projections are transferred, and is a mask for transferring the projections to the target layer and magnetic recording layer formed below the mask layer. Accordingly, the etching selectivity when the mask layer/metal microparticle layer are formed in this order from the substrate side can be as high as possible, and the etching selectivity of the target layer/mask layer is, of course, desirably high.

When the target layer is the magnetic recording layer, the mask layer is formed on the protective layer on the magnetic recording layer. As described above, the etching selectivity of the magnetic recording layer/mask layer can be also high.

The mask layer can be either a single layer or a multilayered film including two or more layers formed by stacking different materials.

The mask layer can have a thickness equal to or smaller than the radius of the metal microparticles in order to accurately transfer the microparticle projections pattern. This is so because if a layer having a thickness larger than the radius of the microparticles is processed, the aggregation of the microparticles during etching as will be described later becomes significant, and the transfer accuracy deteriorates. When a few ten-nm class pattern is assumed, a practical thickness is desirably 1 to 10 nm.

The mask layer is deposited by various methods like the target layer, and can take various arrangements by taking account of the etching selectivity. That is, the mask layer can be either a single layer or a multilayered film including two or more layers formed by stacking different materials.

When using physical or chemical vapor deposition, the thickness of the mask layer can be adjusted by properly changing parameters such as the process gas pressure, gas flow rate, substrate temperature, input power, ultimate vacuum degree, chamber ambient, and deposition time. The arrangement accuracy of a metal microparticle layer to be formed on the mask layer and the transfer accuracy of the projections pattern strongly depend on the surface roughness of the mask layer. Therefore, the surface roughness of the mask layer can be reduced by variously adjusting the above-mentioned deposition conditions. To precisely process a narrow-pitch pattern, the period of the surface roughness can be made smaller than the desired pattern pitch. Also, the value of the average surface roughness is desirably 0.5 nm or less as a value including the substrate/layer to be processed/mask layer. If this value is larger than 0.5 nm, the arrangement accuracy of metal microparticles (to be described later) decreases, and the signal S/N of the magnetic recording medium decreases. However, the following method can enlarge the processing margin of the microparticle mask. Even when using a substrate having roughness larger than that of a conventional substrate, therefore, a projections pattern having a high dimensional accuracy and a few defects can be transferred to the mask layer.

The surface roughness can be reduced by variously changing the above-mentioned deposition conditions, or by changing the mask layer material from a crystalline material to an amorphous material.

The mask layer thickness can be determined by taking account of the etching selectivity to the release layer and magnetic recording layer formed below the mask layer, and the projections pattern dimensions.

A sputtering gas for use in deposition can mainly contain a rare gas such as Ar, and a desired alloy can be deposited by mixing a reactive gas such as O₂ or N₂ in accordance with a mask material to be deposited.

Also, the mask layer thickness can be set to 1 (inclusive) to 50 (inclusive) nm in order to precisely transfer a micropattern. If the thickness is smaller than 1 nm, no uniform mask layer can be deposited. If the thickness exceeds 50 nm, the projections pattern transfer accuracy in the depth direction tends to decrease. Furthermore, a projections pattern having a higher transfer accuracy can be obtained by forming a mask layer having a thickness equal to or smaller than the radius of the microparticles.

As will be described later, when a projections pattern is transferred to the target layer and magnetic recording layer via the mask layer, the mask layer can be removed, or the mask layer can also be intentionally receded while the projections transferred pattern is formed, instead of the step of removing the mask layer. When removing the mask layer, a method such as dry etching or wet etching is applicable. It is also possible to preform a release layer between the target layer and mask layer, and lift off the mask layer from the target layer by removing this release layer.

As described previously, it is possible to form one mask layer or two or more mask layers. That is, a multilayered structure including first and second mask layers can be formed. By forming the first and second mask layers by using different materials, it is possible to increase the etching selectivity and improve the transfer accuracy. For the sake of convenience, the second mask layer will be called a transfer layer with respect to the first mask layer, and a description will be given like “a target layer to be processed (including a magnetic recording layer)/mask layer/transfer layer from the substrate side”.

This transfer layer can properly be selected from various materials by taking account of the etching selectivity to the metal microparticle material and mask layer material. When determining a combination of the mask materials, metal materials corresponding to an etching solution or etching gas can be selected. When combining materials by assuming dry etching, examples are C/Si, Si/Al, Si/Ni, Si/Cu, Si/Mo, Si/MoSi₂, Si/Ta, Si/Cr, Si/W, Si/Ti, Si/Ru, and Si/Hf in the order of the mask layer/transfer layer from the substrate side, and Si can be replaced with SiO₂, Si₃N₄, SiC, or the like. It is also possible to select multilayered structures such as Al/Ni, Al/Ti, Al/TiO₂, Al/TiN, Cr/Al₂O₃, Cr/Ni, Cr/MoSi₂, Cr/W, GaN/Ni, GaN/NiTa, GaN/NiV, Ta/Ni, Ta/Cu, Ta/Al, and Ta/Cr. Note that the stacking order of these various mask materials can be changed in accordance with an etching gas to be used in mask processing. The combination of the mask materials and the stacking order are not limited to those enumerated above, and can properly be selected from the viewpoints of the pattern dimensions and etching selectivity. Since patterning by wet etching is also possible as well as dry etching, each mask material can be selected by taking this into account.

When patterning the mask layer by wet etching, side etch in the widthwise direction of the projections pattern is suppressed. This can be realized by setting various parameters such as the composition of the mask material, the concentration of the etching solution, and the etching time.

### Metal Microparticle Layer Formation Step

Subsequently, a metal microparticle layer for forming a projection pattern is formed on the mask layer. The metal microparticle layer formation process will be explained by separating it into a noble-metal microparticle surface modification step and microparticle coating step.

First, the metal microparticle surface modification step will be explained in detail below.

Microparticles to be used in the embodiments are made of noble metals, and selected from materials such as Au, Ag, Pt, Pd, Ru, Ir, and Rh.

Generally, noble-metal microparticles are chemically stable and hence have a dry etching resistance, so they are materials that can increase the etching selectivity. Also, when compared to oxide microparticles, a Hamaker constant that determines the van der Waals force is large, and the interaction between particles is strong. Accordingly, particles on the substrate surface tend to maintain monodispersion, and form a clear hexagonal array on the substrate surface, so the pitch variation decreases. On the other hand, a strong interaction between particles allows easy aggregation of microparticles. In addition, since the inter-particle distance shortens as the pitch narrows, the processing margin reduces. Furthermore, as the protective groups around the noble-metal microparticles disappear during dry etching, the noble-metal microparticles readily aggregate, and the transfer accuracy of the projections pattern decreases. Therefore, the narrow spacing processing accuracy has a trade-off relationship with a high etching selectivity and low pitch dispersion, so a technique that solves this problem is desired.

Aggregation as described above can be improved by modifying the metal microparticle surface. However, when modifying the microparticle surface by using another metal in the stage of synthesizing metal microparticles, the microparticle size increases by the amount of shell covering the surface. In addition, two or more microparticles fuse to form so-called secondary particles, and this leads to a cause that worsens the monodispersed state in the dispersion. Therefore, to simply modify the surfaces of the metal microparticles without increasing the particle size, a step of adding a solvent containing a polymer chain having a base-metal terminal end to the noble-metal microparticle dispersion is applied. In this step, the second solvent containing the base metal/polymer is added to the first solvent in which the noble-metal microparticles are dispersed.

The noble-metal microparticles can be synthesized by various methods. For example, a liquid-phase reduction method and reverse micelle method are general.

The base-metal terminal end is readily adsorbed to the noble-metal microparticle surfaces in accordance with the magnitude of the bonding energy to the noble-metal microparticles. The term “base metal” herein mentioned is used in this manufacturing method for the sake of convenience, and indicates materials and functional groups other than noble-metal materials. A metal complex is also applicable as the polymer containing the base metal. Furthermore, a new protective group can be formed by substituting the protective group around the noble-metal microparticle with the polymer having the base metal at the terminal end. For example, the surface of an Au noble-metal microparticle can be modified by sulfur by adding a solvent containing a polymer having a thiol terminal end. As will be described later, noble-metal microparticles on the sulfur surface do not immediately aggregate during dry etching. This makes the transfer of a narrow-spacing pattern to a lower layer possible, which is conventionally regarded as difficult.

In the base-metal covering, the noble-metal surface is covered with the molecular terminal end, so the net shell thickness is extremely small. Accordingly, the increase in particle size of the original noble-metal microparticles can be decreased. Also, a noble-metal microparticle equivalent to an inner core covered with the base metal is chemically stable, so no deterioration occurs in the microparticle interface during surface modification. Consequently, a high dry etching resistance is maintained.

The first and second solvents are selected from various solutions and desirably compatible with each other. In addition, the first and second solvents are desirably materials that do not dissolve the noble-metal microparticle protective group. More specifically, the difference between the solubility parameters of these solvents can be set at 6.0 or less. As the solvent species, it is possible to select, e.g., toluene, xylene, hexane, heptane, octane, ethylene glycol monoethyl ether, ethylene glycol monomethyl ether, ethylene glycol monomethyl ether acetate, propylene glycol monomethyl ether acetate, ethylene glycol trimethyl ether, ethyl lactate, ethyl pyruvate, cyclohexanone, dimethylformamide, dimethylacetamide, tetrahydrofuran, anisole, diethylene glycol triethyl ether, alcohol, and water.

The concentration of the noble-metal microparticles in the first dispersion has influence on the uniformity of a coating film (to be described later), and hence can take an optimum range. In practice, however, various adjustments are necessary in accordance with a coating method. The solution concentration is 5% or less as a mass percent concentration. This is so because if this concentration exceeds 5%, the in-plane dependence of the coating film thickness on the substrate significantly worsens.

The base metal contained in the second solvent is made of various materials. For example, it is possible to select N, P, Bi, S, F, Cl, Br, and I, in addition to C, Si, Al, Ti, Cr, Mn, Co, Ni, Cu, Fe, Zn, Zr, Nb, Mo, Hf, Ta, and W. Also, the polymer contained in the second solvent and having the base-metal terminal end need only be compatible with each solvent. For example, it is possible to use polystyrene, polyethylene, polyvinyl pyrrolidone, polyhydroxy styrene, and polymethyl methacrylate.

The base metal/polymer concentration in the second dispersion can be changed in accordance with the concentration of the noble-metal microparticles in the first dispersion. In this case, it is possible to use either the base metal amount or polymer solid component amount as a parameter. Since, however, the base metal amount is extremely small and solution preparation is difficult, the solution concentration can be determined by using the polymer solid component amount in the manufacturing process. In addition, since the polymer having the base-metal terminal end is arranged between microparticles, the wettability to the substrate surface becomes better than that when using only the first solvent. Therefore, the addition of the second solvent also achieves an effect of changing the metal microparticle multilayered structure into a monolayer in the substrate plane.

The base metal/polymer concentration in the second dispersion can be set within the range of 0.01% to 2% as a mass percent. If the concentration is lower than 0.01%, the wettability of the dispersion decreases, and a defective region (0-layer region) is formed in the film. If the concentration is higher than 2%, a metal microparticle multilayered structure is locally formed in the substrate. Also, if the concentration is higher than 2%, the base-metal terminal ends readily aggregate to form clusters, and the amount of dust on the substrate often increases. In addition, the pitch variation of the noble-metal microparticles increases as the polymer film thickness increases. The concentration of the additive solvent can be set at 0.1% to 0.5%.

Next, the noble-metal/base-metal microparticle dispersion coating step will be explained. The substrate surface can be coated with the dispersion by various methods. Practical examples are a spin coating method, spray costing method, spin casting method, dip coating method, inkjet method, Langmuir-Blodgett method, and Langmuir-Shaefer method.

In these methods, the substrate can be coated with a microparticle monolayer by adjusting the concentration of the microparticle dispersion. Also, secondary particles formed by aggregation have a relatively large particle size and may deteriorate the pattern uniformity. Therefore, these secondary particles are desirably appropriately filtered by using a membrane filter or the like.

As described above, a microparticle layer made of the noble-metal core/base-metal shell can be formed on the mask layer. As mentioned earlier, these microparticles have the effects of suppressing aggregation, improving the wettability, and increasing the etching resistance by surface modification, and make it possible to process a narrow-spacing pattern as will be described later.

### Mask Layer Patterning Step

Then, the projections pattern is transferred to the mask layer by using the metal microparticles. As described previously, when the noble-metal microparticle surfaces are modified by the base metal and polymer, the obtained structure can be regarded as a system in which an island-like pattern of the microparticles and a sea-like pattern of the polymer coexist. In this case, the projections pattern of the microparticles can be transferred by removing the sea-like pattern.

When processing the mask layer, it is possible to implement various layer arrangements and processing methods by combining mask layer materials and etching gases.

Dry etching is applicable when performing micropatterning such that etching in the thickness direction of the projections pattern is significant with respect to etching in the widthwise direction. A plasma to be used in dry etching can be generated by various methods such as capacitive coupling, inductive coupling, electron cyclotron resonance, and multi-frequency superposition coupling. Also, to adjust the pattern dimensions of the projections pattern, it is possible to set parameters such as the process gas pressure, gas flow rate, plasma input power, bias power, substrate temperature, chamber ambient, and ultimate vacuum degree.

When stacking mask materials in order to increase the etching selectivity, an etching gas can properly be selected. Examples of the etching gas are fluorine-based gases such as CF₄, C₂F₆, C₃F₆, C₃F₈, C₅F₈, C₄F₈, ClF₃, CCl₃F₅, C₂ClF₅, CCBrF₃, CHF₃, NF₃, and CH₂F₂, and chlorine-based gases such as Cl₂, BCl₃, CCl₄, and SiCl₄. Other various gases such as H₂, N₂, O₂, Br₂, HBr, NH₃, CO, C₂H₄, He, Ne, Ar, Kr, and Xe can also be applied. It is also possible to use a gas mixture obtained by mixing two or more types of these gases in order to adjust the etching rate or etching selectivity. Note that patterning can also be performed by wet etching. In this case, it is favorable to select an etching solution capable of securing the etching selectivity and suppressing etching in the widthwise direction. Similarly, physical etching such as ion milling can be performed.

Since the noble-metal microparticle surfaces are covered with the base metal having low activity, aggregation reduces against plasma exposure during dry etching. Consequently, the projections pattern transfer accuracy can be improved.

The mask layer can have various arrangements by taking account of the etching selectivity to the metal microparticle layer. As described previously, examples are arrangements such as C/Si, Ta/Al, Al/Ni, and Si/Cr from the substrate side.

If the spacings between the metal microparticles are significantly narrow, it is possible to adjust the microparticle spacings by intentionally etching the metal microparticle film. Examples of practical methods are a method of increasing side etch of dry etching, and a method of slimming the metal microparticles in the widthwise direction by adjusting the incident angle of the ion species in ion milling. As described above, the projections pattern can be formed on the resist layer by using the metal microparticle mask.

It is also possible to remove the metal microparticles from the mask layer after the metal microparticle pattern is transferred to the mask layer. When the metal microparticles are removed, it is possible to reduce the closure of pattern grooves caused by an etching byproduct, and reduce the aggregation of the microparticles. Practical methods are a method of dissolving the metal microparticles themselves, and a method of removing the metal microparticles by affiliating the protective groups around the metal microparticles with the solvent. In the former method, damages to the mask layer and substrate are unavoidable because a strong acid or strong base must be used. By contrast, the latter method can release the metal microparticles by using only an organic solvent as a dispersion medium, and hence can achieve both the flatness of the substrate surface and low damage.

When the noble-metal microparticles are exposed to the plasma of dry etching, however, the protective groups covering the surfaces of the microparticles cleave, so the microparticles lose the affinity for the solvent. This makes it difficult to remove the microparticles from the mask layer surface. In this case, physical removal of the microparticles by dry etching is possible as one method. Since, however, the microparticles aggregate as etching advances, the removal of the projections and the pattern transfer accuracy enter into a trade-off relationship.

Accordingly, the microparticles are readily removed from the mask layer surface by applying the above-mentioned method to the release method as well. More specifically, the metal microparticles are removed by using the second solvent containing the base metal/polymer as the release solution.

When the solvent containing the base metal/polymer is used for the noble-metal microparticles deactivated by dry etching, the base-metal microparticles are adsorbed to the noble-metal microparticle surfaces. On the other hand, the polymer chain affiliates with the solvent and releases the noble-metal microparticles from the substrate surface. Therefore, it is possible to release the metal microparticles from the mask layer surface by only dipping the substrate into the organic solvent, and extremely reduce damages to the mask layer and substrate. If the noble-metal microparticles cannot completely be released by the solvent alone, it is possible to secondarily apply a method such as ultrasonic cleaning or scrub cleaning.

The above-described noble-metal/base-metal microparticle layer can also be used as a liftoff layer. A nanoimprinting stamper manufacturing method using this method will be explained below.

In nanoimprinting, pattern transfer is performed by pressing a nanoimprinting stamper (to be referred to as a stamper hereinafter) having a projections micropattern formed on the surface against a transfer resist layer. Compared to step-and-repeat ultraviolet exposure or electron beam exposure, a resist pattern can be transferred to a large area of a sample at once. Since the manufacturing throughput increases, therefore, it is possible to shorten the manufacturing time and reduce the cost.

The stamper can be obtained from a substrate having a projections micropattern formed by lithography or the like, i.e., a so-called master template (mold or template). In many cases, the stamper is manufactured by electroforming the micropattern of the master template. As the substrate of the master template, it is possible to use Si, SiO₂, SiC, SiOC, Si₃N₄, C, or a semiconductor substrate in which an impurity such as B, Ga, In, or P is doped. Also, the three-dimensional shape of the substrate is not limited, so a circular, rectangular, or doughnut-like substrate can be used. A substrate made of a conductive material can also be used.

An example in which the above-described noble-metal microparticle layer is used as a pattern layer/liftoff layer will be explained below. Although the pattern of the master template can be formed by various lithography processes, a periodic microstructure made of metal microparticles is used in this example. After projections are formed in the metal microparticles, a stamper is obtained by electroforming, i.e., electroplating the metal microparticles. It is also possible to transfer the metal microparticle projections to the mask layer or substrate, and use the transferred projections as an electroforming pattern. When forming projections in the metal microparticles, the polymer filled around the microparticles can be removed by dry etching. In this process, it is important to suppress the aggregation of the metal microparticles.

Subsequently, a stamper is manufactured by electroforming the projections pattern of the master template. Although various materials can be used as a plating metal, a method of manufacturing an Ni stamper will be explained as an example. First, a thin Ni film is deposited on the surface of the projections pattern of the master template in order to give conductivity to the projections pattern. If a conduction defect occurs during electroforming, plating growth is obstructed, and this leads to a pattern defect. Therefore, the thin Ni film can evenly be deposited on the upper surface and side surfaces of the projections pattern. Note that this film is formed to give conductivity, so the material is not limited to Ni.

Subsequently, the master template is dipped in an Ni sulfamate bath, and electroforming is performed by supplying an electric current. The film thickness after the plating, i.e., the thickness of the stamper can be adjusted by changing, e.g., the hydrogen ion concentration, temperature, and viscosity of the plating bath, the electric current value, and the plating time. This electroforming can be performed by electroplating or electroless plating.

The stamper obtained as described above is released from the substrate. If the stamper is physically released from the substrate as in the conventional methods, the shape of the stamper changes because a stress is applied to it, and the flatness of the stamper deteriorates. This produces unevenness in projections pattern transfer in nanoimprinting (to be described later), thereby largely deteriorating the pattern transfer properties to the resist layer. Also, if a release layer is formed on the substrate as in the conventional methods, the releasability of the release layer deteriorates due to the diffusion of the metal material into the interface between the release layer and the electroformed layer on it. As a consequence, physical release from the substrate is inevitable.

By contrast, the releasability of the stamper from the substrate is improved by modifying the noble-metal microparticle surfaces by the base metal/polymer as described previously. In this step, the second solvent containing the polymer chain having the base-metal terminal end is used as a release solution. Since the metal microparticles readily leave the substrate by using this release solution, no physical release is necessary for the stamper. Since, therefore, the stamper can be released from the substrate surface without producing any strain by the application of a stress, the manufactured stamper has a high flatness. Also, liftoff can be performed without using any strong acid or strong base unlike in the conventional methods, almost no damage is conflicted to the stamper by the release solution, so the accuracy of the projections pattern does not deteriorate.

After the release, the noble-metal microparticles on the projections pattern surface of the stamper are removed by a method such as dry etching. In this case, the etching selectivity between the stamper material and noble-metal microparticles can be as low as possible, and only the microparticles can easily be removed. Finally, the stamper is completed by mechanically removing unnecessary portions except for the projections pattern surface, and processing the stamper into a desired shape such as a circle or rectangle.

Note that the projections pattern is transferred to the resist layer by using the obtained stamper. In this step, a duplicated stamper can be manufactured by using the stamper in place of the master template. Examples are a method of obtaining an Ni stamper from an Ni stamper, and a method of obtaining a resin stamper from an Ni stamper. In this specification, a method of manufacturing a resin stamper will be explained.

A resin stamper is manufactured by injection molding. First, an Ni stamper is loaded into an injection molding apparatus, and injection molding is performed by supplying a resin solution material to the projections pattern of the stamper. As the resin solution material, it is possible to apply a cycloolefin polymer, polycarbonate, or polymethyl methacrylate, and select a material having a high removability with respect to an imprint resist. After the injection molding is performed, a resin stamper having the projections pattern is obtained by releasing the sample from the Ni stamper.

The projections pattern is transferred to the resist layer by using this resin stamper.

As the resist, it is possible to use a resist material such as a thermosetting resin or photosetting resin. Examples are isobornyl acrylate, allyl methacrylate, and dipropylene glycol diacrylate.

A sample including the magnetic recording layer and mask layer as described above is coated with any of these resist materials, thereby forming a resist layer. Then, a resin stamper having a projections pattern is imprinted on the resist layer. When the resist stamper is pressed against the resist during this imprinting, the resist fluidifies and forms a projections pattern. The resist layer forming the projections pattern is cured by applying energy such as ultraviolet light to the resist layer. Then, the projections pattern of the resist layer is obtained by releasing the resin stamper. To facilitate releasing the resin stamper, a release treatment using a silane coupling agent or the like can be performed on the surface of the resin stamper beforehand.

Since the resist material remains as a residue in the recesses of the resist layer after the resin stamper is released, the surface of the mask layer is exposed by etching away the residue. The residue can easily be removed by dry etching using O₂ gas, because a polymer-based resist material generally has a low etching resistance against an O₂ etchant. If an inorganic material is contained, an etchant can properly be changed so that the resist pattern remains. As described above, the projections pattern can be formed on the resist layer by nanoimprinting.

### Layer to be Processed Patterning Step

Subsequently, the projections pattern transferred to the mask layer is transferred to the lower layer to be processed. This layer to be processed corresponds to a magnetic recording layer in a magnetic recording medium manufacturing method.

When forming the projections pattern on the target layer, various processing methods can be selected like the above-described mask layer. However, dry etching can be applied in order to decrease a dimensional conversion difference in the widthwise direction and advance processing in the thickness direction. Note that no aggregation of noble-metal microparticles occurs due to etching when the microparticles are removed from the mask layer before the target layer formation step. Accordingly, the projections pattern transfer accuracy can be improved.

Also, when a noble-metal material that hardly forms a byproduct by reactive dry etching is used as the target layer, a method such as ion milling need only be applied. More specifically, an inert gas such as He, Ne, Ar, Xe, or Kr can be used, and it is also possible to perform patterning by reactive ion milling to which a gas such as O₂ or N₂ is added.

When patterning the target layer, the relationship between an etching rate ERmask of the mask layer and an etching rate ERmat of the target layer desirably satisfies ERmask≦ERmat. That is, to obtain desired thicknesses of the target layer and magnetic recording layer, the reduction in amount of the mask layer caused by etching can be decreased.

When transferring the projections structure to the magnetic recording layer by ion milling, it is important to suppress a byproduct, i.e., a so-called redeposition component that scatters toward the mask sidewalls as the processing advances. Since this redeposition component adheres around the projection pattern mask, the projection pattern increases the dimensions and fill the grooves. To obtain divided projections patterns, therefore, it is possible to reduce the redeposition component as soon as possible.

When performing ion milling on the target layer, the redeposition component on the sidewalls can be reduced by changing the ion incident angle. Although an optimum incident angle changes in accordance with the mask height, redeposition can be suppressed within the range of 20° to 70°. Also, the ion incident angle can appropriately be changed during milling. An example is a method in which after the target layer is milled at an ion incident angle of 0°, the redeposition component on the projection pattern is selectively removed by changing the ion incident angle.

### Protective Layer Formation Step

In the magnetic recording medium manufacturing method in which a magnetic recording layer is the target layer, a magnetic recording medium having the projections pattern can be obtained by finally depositing a carbon-based protective layer and a fluorine-based lubricating film (not shown) on the magnetic recording layer pattern having projections.

As the carbon protective layer, a DLC film containing a large amount of sp³-bonded carbon can be used. The film thickness of the protective layer is set to 2 nm or more in order to maintain the coverage, and 10 nm or less in order to maintain the signal S/N. Also, perfluoropolyether, alcohol fluoride, or fluorinated carboxylic acid can be used as a lubricant.

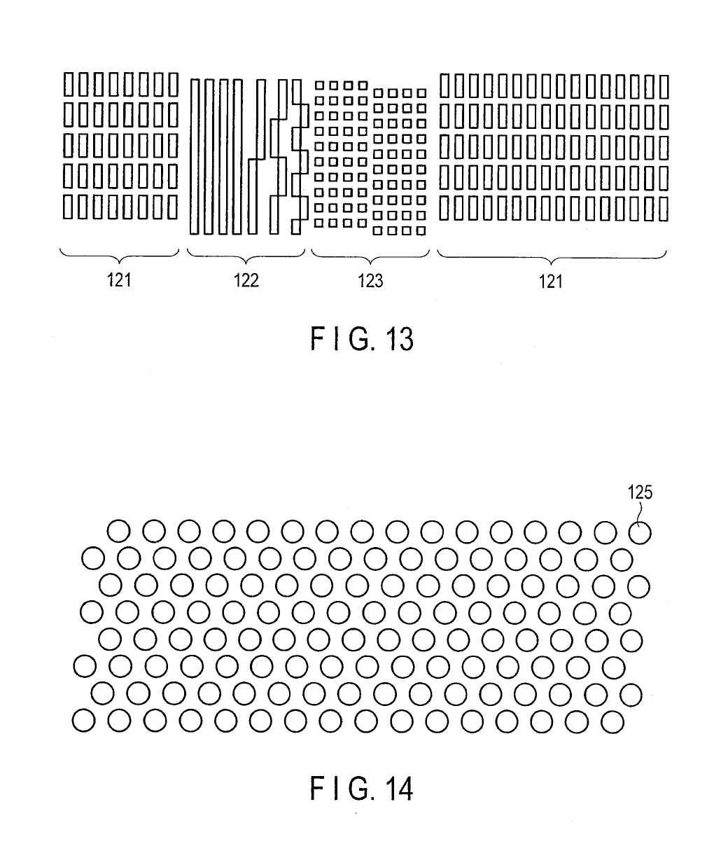

FIG. 13 is a view showing examples of recording bit patterns in the circumferential direction of the magnetic recording medium.

As shown in FIG. 13, the projection patterns of the magnetic recording layer are roughly classified into a recording bit area 121 for recording data corresponding to 1 and 0 of digital signals, and a so-called servo area 124 including a preamble address pattern 122 as a magnetic head positioning signal, and a burst pattern 123. These patterns can be formed as in-plane patterns. Also, the patterns in the servo area shown in FIG. 13 need not have rectangular shapes. For example, all the servo patterns may also be replaced with dot-like patterns.

Furthermore, as shown in FIG. 14, not only the servo area but also the data area can entirely be formed by a dot pattern 120. One-bit information can be formed by one magnetic dot or a plurality of magnetic dots.

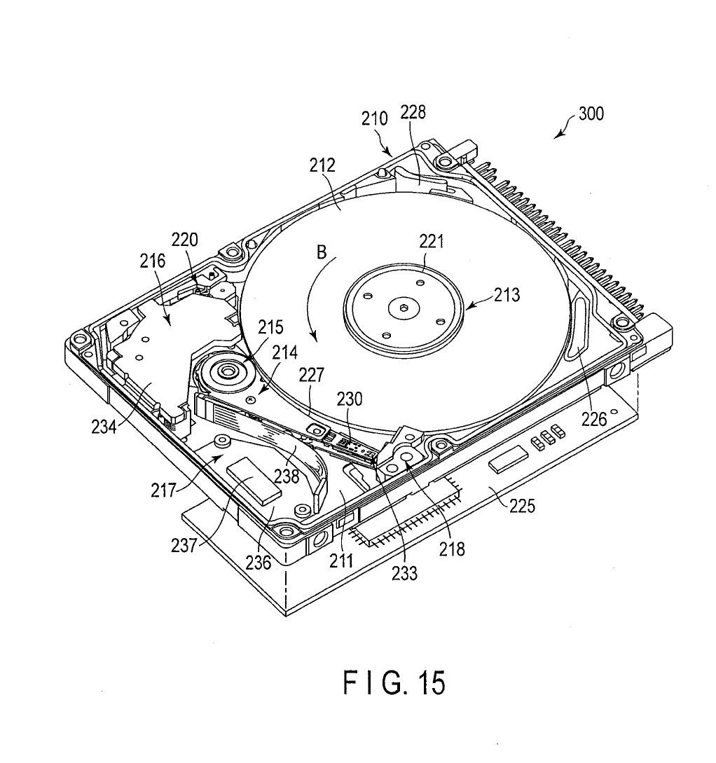

FIG. 15 is a partially exploded perspective view showing an example of a magnetic recording/reproduction apparatus to which the magnetic recording medium according to the embodiment is applicable.

As a disk apparatus 300, FIG. 15 shows the internal structure of a hard disk drive (HDD) according to the embodiment by removing its top cover. As shown in FIG. 15, the HDD includes a housing 210. The housing 210 includes a rectangular boxy base 211 having an open upper end, and a rectangular plate-like top cover (not shown). The top cover is fixed to the base by a plurality of screws, and closes the open upper end of the base. Consequently, the interior of the housing 210 is airtightly held, and can communicate with the outside through only a breathing filter 226.

A magnetic disk 212 as a recording medium and a driving unit are arranged on the base 211. The driving unit includes a spindle motor 213 for supporting and rotating the magnetic disk 212, a plurality of, e.g., two magnetic heads 233 for performing information recording and reproduction on the magnetic disk, a head actuator 214 for supporting the magnetic heads 233 such that they can freely move over the surface of the magnetic disk 212, and a voice coil motor (to be referred to as a VCM hereinafter) 216 for pivoting and positioning the head actuator. A ramped loading mechanism 218, inertia latch 220, and substrate unit 217 are also arranged on the base 211. The ramped loading mechanism 218 holds the magnetic heads 233 in a position spaced apart from the magnetic disk 212 when the magnetic heads 233 have moved to the outermost circumference of the magnetic disk 212. The inertia latch 220 holds the head actuator 214 in a retracted position when an impact or the like acts on the HDD. The substrate unit 217 includes electronic parts such as a preamplifier and head IC.

A control circuit board 225 is screwed to the outer surface of the base 211, and faces the bottom wall of the base 211. The control circuit board 225 controls the operations of the spindle motor 213, VCM 216, and magnetic heads 233 via the substrate unit 217.

Referring to FIG. 15, the magnetic disk 212 is formed as a perpendicular magnetic recording medium having a projection pattern formed by the above-described processing method. Also, as described previously, the magnetic disk 212 has a substrate 219 made of a disk-like nonmagnetic member having a diameter of about 2.5 inches. On each surface of the substrate 219, a soft magnetic layer 223 as an underlayer and a perpendicular magnetic recording layer 222 having magnetic anisotropy perpendicular to the disk surface are sequentially stacked. A protective film 224 is formed on the perpendicular magnetic recording layer 222.

Also, the magnetic disk 212 is coaxially fitted on a hub of the spindle motor 213 and fixed to the hub by being clamped by a clamp spring 221 screwed to the upper end of the hub. The spindle motor 213 as a driving motor rotates the magnetic disk 212 at a predetermined speed in the direction of an arrow B.

The head actuator 214 includes a bearing 215 fixed on the bottom wall of the base 211, and a plurality of arms 227 extending from the bearing. The arms 227 are arranged parallel to the surface of the magnetic disk 212, spaced apart from each other at a predetermined distance, and extend in the same direction from the bearing 215. The head actuator 214 includes elastically deformable narrow plate-like suspensions 230. The suspensions 230 are formed by leaf springs, and have proximal ends fixed to the distal ends of the arms 227 by spot welding or adhesion and extending from the arms. The magnetic heads 233 are supported by the extended ends of the suspensions 230 via gimbal springs 241. The suspensions 230, gimbal springs 241, and magnetic heads 233 form a head gimbal assembly. Note that the head actuator 214 may also have a so-called E block formed by integrating a sleeve of the bearing 215 and the plurality of arms.

### EXAMPLES

The embodiments will be explained in more detail below by way of its examples.

### Example 1

Example 1 is an example in which a projections micropattern was formed by using noble-metal/base-metal microparticles.

First, a coating solution for forming a metal microparticle mask was prepared. As described previously, this solution contained the first solvent containing noble-metal microparticles, and the second solvent containing a polymer chain having a base-metal terminal end.

In this example, an Au dispersion containing 2.8 wt % of noble-metal microparticles was prepared by using Au microparticles having an average particle size of 8 nm and a pitch of 13.5 nm as the noble-metal microparticles, and toluene as the first solvent.

Also, polystyrene having a thiol group was used as the base-metal material portion, and toluene was used as the second solvent. A polystyrene solution was prepared by setting the average molecular weight of polystyrene at 1,300, and the mass percent concentration with respect to the second solvent at 0.5%.

This polystyrene functions as a binder between microparticles and between the microparticles and a substrate during microparticle coating. Then, an Au microparticle layer coating solution was prepared by adding the polystyrene solution to the Au dispersion. As described earlier, by the addition of this solution, the Au microparticle surfaces were sufficiently covered with sulfur, and the microparticles were isolated from each other by polystyrene. Also, when polystyrene was added, the density of protective groups between the microparticles increased, so the monodispersion of the microparticles stabilized. This made it possible to reduce aggregation from the subsequent step. Note that in this example, the Au microparticle concentration in the dispersion was optimized at 2.8% as a mass percent concentration in order to obtain a monolayer region over a broad range during coating. In addition, to promote the monodispersion of the Au microparticles after the solution was prepared, the coating solution was prepared by performing ultrasonic dispersion for 90 min.

Then, a projections pattern formation substrate was prepared. A 2.5-inch doughnut-like glass disk was used as the substrate, and Si was used as a target layer to be processed. The Si layer to be processed was deposited by DC sputtering. In this step, a 5-nm thick layer was deposited by using Ar gas at a gas pressure of 0.7 Pa and an input power of 500 W.

Subsequently, the target layer was coated with the Au microparticle layer coating solution, thereby forming a microparticle monolayer.

As described earlier, the “monolayer” means a state in which microparticles have no multilayered structure in the same plane and are arranged into a single layer.

The prepared Au microparticle layer solution was dropped on the target layer by using an automatic syringe, and spin coating was performed at a rotational speed of 5,000 rpm, thereby forming an Au microparticle monolayer.

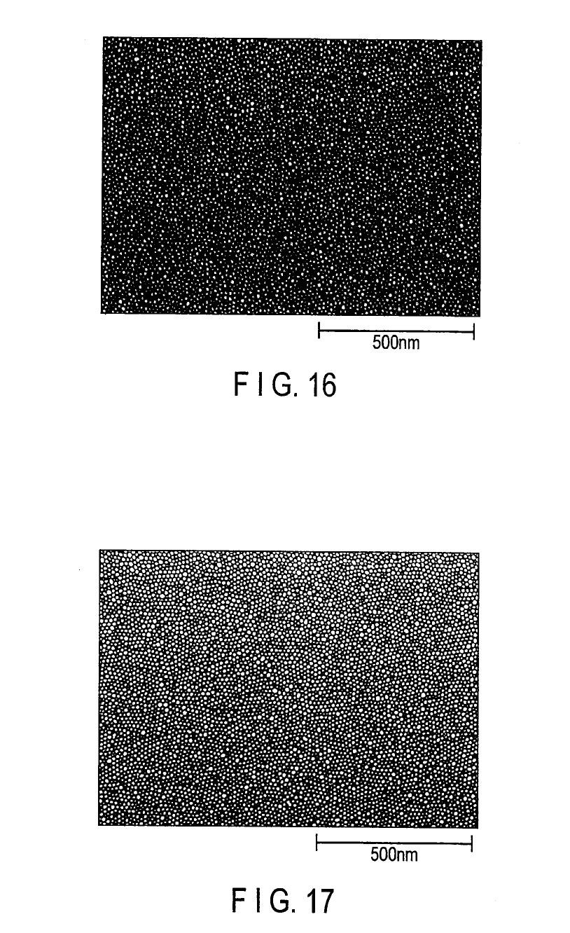

FIG. 16 shows a result when the substrate coated with the microparticles was observed with a scanning electron microscope (SEM). As shown in FIG. 16, the Au microparticles maintained a dispersed state from each other, and no aggregation was found on the substrate. Also, when the thickness of the metal microparticle layer was measured using an atomic force microscope (AFM), a step of 9 nm was found, i.e., it was confirmed that the microparticles were formed into a monolayer.

A projections pattern was formed by performing dry etching on this Au microparticle mask. Since the surfaces of the Au microparticles were covered with sulfur, aggregation was less than that when Au microparticles alone were used, and a highly uniform pattern was obtained. This dry etching was performed by an inductively coupled plasma reactive ion etching apparatus by using CF₄ gas as an etchant. Also, etching was performed for 15 sec at a process gas pressure of 0.1 Pa, a gas flow rate of 20 sccm, an antenna power of 100 W, and a bias power of 30 W, thereby removing the polymer binder and etching the Si layer to be processed by 5 nm.

FIG. 17 shows a result when the upper surface of the dry-etched sample was observed with the SEM. The metal microparticles maintained monodispersion, and no aggregation occurred. Also, when the sectional structure of the sample was checked using a transmitting electron microscope, projections of about 5 nm were formed on the Si layer to be processed.

### Example 2

Example 2 is an example in which Au microparticles were removed from projections formed in the same manner as in Example 1.

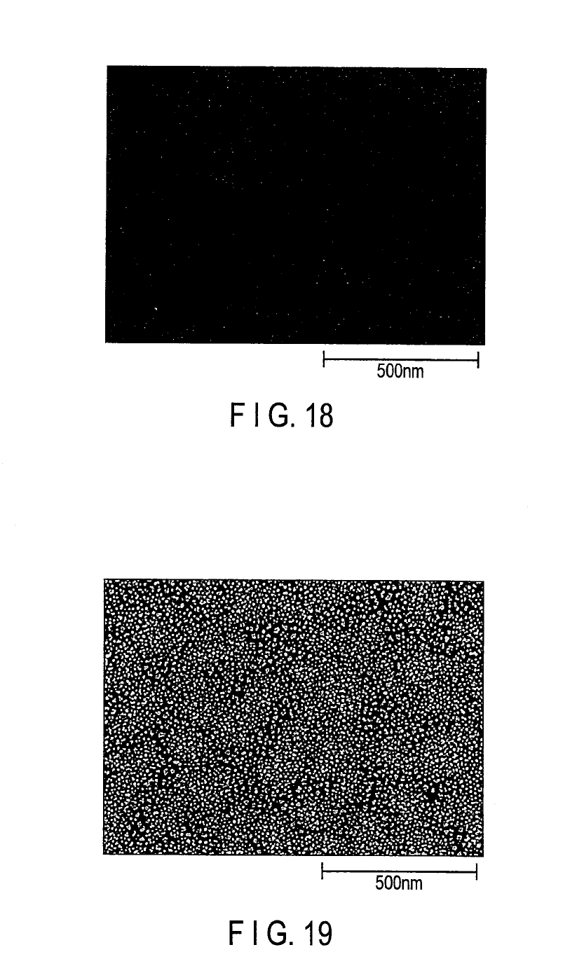

After dry etching was performed on an Si layer to be processed, Au microparticles were removed by wet etching. A solution mixture prepared by diluting iodine and potassium iodide with isopropyl alcohol at a weight ratio of 1:1:12 was prepared as an etchant. Then, the sample was dipped in the solution mixture for 5 min, and cleaned by washing using isopropyl alcohol. FIG. 18 shows an upper-surface SEM image of the sample from which the microparticles were removed. A projections pattern was confirmed on the SEM, and the projections contrast decreased. That is, it was confirmed that the Au microparticles were dissolved away, and Si projections were formed.

### Example 3

Examples 3 to 24 are results when magnetic recording media were manufactured by using noble-metal/base-metal microparticles as masks and the head floating characteristics of the media were evaluated.

An example using a sample having a common layer configuration will be explained below. First, a magnetic recording layer was formed on a glass substrate. A 2.5-inch doughnut substrate was used as the substrate, and a magnetic recording layer was formed on the substrate by DC sputtering. Ar was used as a process gas, the gas pressure was set at 0.7 Pa, the gas flow rate was set at 35 sccm, the input power was set at 500 W, a 10-nm thick NiTa underlayer/4-nm thick Pd underlayer/20-nm thick Ru underlayer/3-nm thick CoPt recording layer were sequentially deposited from the substrate side, and a 1-nm thick Pd protective layer was finally formed, thereby obtaining a magnetic recording layer.

Then, a mask layer was formed. A C film was selected as the mask layer, and an Si film was used as a transfer layer on the mask layer in order to improve the transfer accuracy. The two mask layers were formed by DC sputtering by setting the thickness of the C film to 15 nm, and the thickness of the Si film to 5 nm.

Then, a microparticle solution was prepared. The preparation of the microparticle solution, coating, and transfer to the Si transfer layer were the same as those of Example 1. Note that before the projections pattern was transferred to the C film, the Au microparticles were dissolved away from the Si transfer layer following the same procedure as in Example 2.

When transferring the projections pattern to the C film, dry etching using O₂ gas as an etchant was applied. That is, the projections pattern was transferred to the C film by performing etching for 29 sec at a gas pressure of 0.1 Pa, a gas flow rate of 20 sccm, an antenna power of 40 W, and a bias power of 40 W.

Subsequently, the projections pattern was transferred to the magnetic recording layer. When transferring the projections pattern to the magnetic recording layer, ion milling was applied. In this step, a milling method using Ar ions was applied. The projections pattern was transferred to the CoPt recording layer by performing milling for 55 sec at an Ar ion acceleration voltage of 300 V, a gas flow rate of 3 sccm, and a process pressure of 0.1 Pa, by setting the ion species incident angle to the substrate surface at 90° (perpendicular incidence). The Si transfer layer and C mask layer disappeared during ion milling, and hence did not remain on the CoPt recording layer.

Finally, a 2-nm thick DLC film was deposited, and a 1.5-nm thick perfluoropolyether-based lubricating film was formed after that, thereby obtaining a magnetic recording medium having the projections pattern.

A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 4

Example 4 is the same as Example 3 except that the solid component concentration in the second solvent was 1 wt %.

A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 5

Example 5 is the same as Example 3 except that the mass percent concentration of the noble-metal microparticle solution was 2.5%.

A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 6

Example 6 is the same as Example 3 except that the mass percent concentration of the noble-metal microparticle solution was 3%.

A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 7

Example 7 is the same as Example 3 except that the mass percent concentration of the noble-metal microparticle solution was 3.5%.

A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 8

Examples 8 to 13 are results when various materials were applied as the noble-metal microparticles, and polymer materials having various protective groups were applied as the base-metal material. The first solvent, the second solvent, the second solvent concentration, the noble-metal microparticle dispersion concentration, and the method of transferring projections to a magnetic recording medium were the same as those of Example 3.

In this example, Ag having an average particle size of 9.7 nm was used. Also, polystyrene having a thiol terminal end was used as the binder as in Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 9

Example 9 is the same as Example 8 except that Pt was used as the noble-metal microparticle material.

In this example, Pt having an average particle size of 18 nm was used. Also, polystyrene having a thiol terminal end was used as the binder as in Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 10

Example 10 is the same as Example 8 except that Pd was used as the noble-metal microparticle material, and Si-polystyrene was used as the polymer chain having the base-metal terminal end.

In this example, Pd having an average particle size of 10 nm was used. Also, polystyrene having a siloxane terminal end was used as the binder.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 11

Example 11 is the same as Example 8 except that Ir was used as the noble-metal microparticle material, and Cl-polystyrene was used as the polymer chain having the base-metal terminal end.

In this example, Pd having an average particle size of 8.2 nm was used. Also, polystyrene having a chloro terminal end was used as the binder.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 12

Example 12 is the same as Example 8 except that Rh was used as the noble-metal microparticle material, and SH-polystyrene was used as the polymer chain having the base-metal terminal end.

In this example, Rh having an average particle size of 14 nm was used. Also, polystyrene having a thiol terminal end was used as the binder.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 13

Example 13 is the same as Example 8 except that Ru was used as the noble-metal microparticle material, and Cl-polystyrene was used as the polymer chain having the base-metal terminal end.

In this example, Ru having an average particle size of 19.9 nm was used. Also, polystyrene having a chloro terminal end was used as the binder.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 14

Example 14 is a result when the second solvent was changed, and other steps were the same as those of Example 3

In this example, the second solvent was changed from toluene to hexane.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 15

Example 15 is a result when the second solvent was changed from toluene to propylene glycol monomethyl ether acetate, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 16

Example 16 is a result when the second solvent was changed from toluene to tetrahydrofuran, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 17

Example 17 is a result when the second solvent was changed from toluene to hexyl acetate, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 18

Examples 18 to 21 are results when the polymer material contained in the second solvent was changed. In these examples, the base-metal material portion was a thiol terminal end.

In this example, the polymer material was methyl methacrylate, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 19

Example 19 is an example in which the polymer material contained in the second solvent was changed from polystyrene to polybutadiene, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 20

Example 20 is an example in which the polymer material contained in the second solvent was changed from polystyrene to polyisoprene, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 21

Example 21 is an example in which the polymer material contained in the second solvent was changed from polystyrene to polyethylene, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 22

Examples 22 to 24 are examples in which alloys were used as the noble-metal microparticle material.

In this example, PtFe was applied as the noble-metal microparticle portion, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 23

Example 23 is an example in which IrPd was used as the noble-metal microparticle material, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 24

Example 24 is an example in which PdSi was used as the noble-metal microparticle material, and other steps were the same as those of Example 3.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 25

Example 25 discloses an example in which a nanoimprinting stamper was manufactured by using noble-metal microparticles as a projections pattern.

First, a master template using microparticles was manufactured in order to manufacture a nanoimprinting stamper. As described previously, a projections microstructure was formed on the master template by using noble-metal nanoparticle. Furthermore, it is possible to improve the releasability from a substrate and manufacture a stamper having a small strain by using a polymer-containing solvent having a base-metal terminal end.

A general-purpose, 6-inch Si wafer was used as the substrate. This wafer was coated with Au microparticles in the same manner as in Example 3. When preparing an Au microparticle solution, polystyrene having a sulfur terminal end was used as described above, and the solution was prepared such that the polystyrene solid component concentration was 0.5% as a mass percent, and the Au concentration was 2.8% as a mass percent. In this step, an Au microparticle monolayer was obtained by performing spin coating at 5,000 rpm for 60 sec.

Then, a conductive film was formed on the Au microparticle pattern in order to perform electroforming on the obtained projections pattern. In this example, Ni was used to evenly form a 5-nm thick Ni conductive film on the Au microparticle pattern by DC sputtering at an ultimate vacuum degree of 8.0×10⁻⁴ Pa, an Ar gas pressure of 1.0 Pa, and a DC input power of 200 W. As the conductive film formation method, it is also possible to use vapor deposition instead of sputtering, or to use an Ni—P alloy or Ni—B alloy formed by electroless plating. Furthermore, the surface may also be oxidized after the conductive film is formed, in order to facilitate releasing a stamper. This conductive film was deposited only in the vicinity of the upper portion of the Au microparticle layer, and was not deposited between the microparticles and on the substrate surface side because the pattern spacings were significantly narrow. Accordingly, the metal microparticles were carried by the conductive film, and the conductive film had uniform conductivity.

Subsequently, an Ni electroformed layer was formed along the projections pattern by electroforming. As an electroforming solution, a high-concentration nickel sulfamate plating solution (NS-169) available from SHOWA CHEMICAL was used. A 300-μm thick Ni stamper was manufactured by using 600 g/L of nickel sulfamate, 40 g/L of boric acid, and 0.15 g/L of a sodium lauryl sulfate surfactant at a liquid temperature of 55° C., a pH of 3.8 to 4.0, and an electric current density of 20 A/dm².

A nanoimprinting stamper having the projections pattern is obtained by releasing this Ni stamper from the master template. When releasing the stamper from the substrate, however, the Ni film has a strain, and in-plane unevenness occurs in the projections pattern after nanoimprinting. By contrast, a stamper having a small physical strain is obtained by using the above-described solvent containing the base metal/polymer as a release solution.

In this example, sulfur-terminal-end polystyrene/toluene solution prepared at a mass percent concentration of 5.0% was used. The Si wafer/electroformed layer stack was dipped in the prepared solution for 10 min, thereby performing release. Consequently, it was possible to release the Ni electroformed layer without physically peeling it from the wafer, so a stamper having a small strain was obtained. Also, since the Au nanoparticles as the projection pattern were simultaneously released as the electroformed layer, a stamper having a small pattern dimensional variation was obtained.

Particles released from the master template existed in the recesses of the released stamper, so these particles were removed from the stamper by performing oxygen ashing. In this ashing, an asher including a barrel type chamber was used, and the particles were removed from the recesses by performing ashing for 30 sec by setting the oxygen flow rate at 20 sccm and the input power at 200 W. Although not explained in this example, it is also possible to remove the resist material by wet removal by using an organic solvent or acid. Finally, the electroformed Ni plate was punched into a 2.5-inch disk shape, thereby obtaining a nanoimprinting Ni stamper.

A resin stamper was duplicated by performing an injection molding process on this Ni stamper. As the resin material, a cyclic olefin polymer (ZEONOR 1060R) available from ZEON was used.

A projections pattern was formed on a resist layer by using the resin stamper obtained as described above. First, a medium sample was spin-coated with a 10-nm thick ultraviolet-curing resist, thereby forming a resist layer. Subsequently, the resin stamper was imprinted on the resist layer, and the resist layer was cured by ultraviolet irradiation (ultraviolet light was radiated while the resin stamper was pressed against the ultraviolet-curing resin layer). A desired 8-nm dot pattern was obtained by releasing the resin stamper from the cured resist layer.

The resist residue formed by imprinting in the grooves of the projection pattern of the sample was removed by etching. This resist residue removal was performed by plasma etching using an O₂ etchant. The resist residue was removed by performing etching for 8 sec at an O₂ gas flow rate of 5 sccm, a pressure of 0.1 Pa, an input power of 100 W, and a bias power of 10 W.

### Example 26

Examples 26 to 28 are results when the total roughness of the substrate/layer to be processed/mask layer was changed, and a change in head floating characteristic caused by a change in surface roughness was checked.

This example is a result when a total average surface roughness Ra of the mask was 0.5 nm, and other steps were the same as those of Example 3. The roughness was adjusted by changing the sputtering pressure when forming the mask layer. Note that it was confirmed that the projection pattern transfer accuracy of the mask having an average surface roughness of 0.5 nm did not deteriorate.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 27

Example 27 is a result when the total average surface roughness of the mask was 0.6 nm, and other steps were the same as those of Example 3. The roughness was adjusted by changing the sputtering pressure when forming the mask layer. Note that it was confirmed that the projections pattern transfer accuracy of the mask having an average surface roughness of 0.6 nm did not deteriorate.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Example 28

Example 28 is a result when the total average surface roughness of the mask was 0.7 nm, and other steps were the same as those of Example 3. The roughness was adjusted by changing the sputtering pressure when forming the mask layer. Note that it was confirmed that the projections pattern transfer accuracy of the mask having an average surface roughness of 0.7 nm did not deteriorate.

Following the same procedures as in Example 3, preparation and coating of metal microparticles were performed, and a projections pattern was transferred to a magnetic recording layer. A head floating amount with respect to the obtained magnetic recording medium was measured by a glide height tester, thereby evaluating the floating characteristic. Consequently, it was possible to pass a floating amount of 8 nm as a standard necessary to evaluate the read/write characteristic of the medium.

### Comparative Example 1

Comparative Examples 1 and 2 are results when the concentration of the polymer-containing solution to be added to the microparticle solution was changed. These comparative examples show results when Au was used as the noble-metal microparticles, sulfur was used as the covering material, toluene was used as the first and second solvents, and polystyrene was used as the polymer. Note that the concentration of the Au microparticle solution was 2.8% as a mass percent.

This example is a result when polystyrene having a molecular weight of 1,300 was used, and the solution concentration was set at 1.5% as a mass percent, and other steps were the same as those of Example 3.

Following the same procedures as in Example 3, preparation and coating of metal microparticles were performed, and a projections pattern was transferred to a magnetic recording layer. Consequently, aggregates were formed on the medium because the polystyrene concentration was high, and a projections difference of a few ten nm was produced. Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 2

Comparative Example 2 is a result when the concentration of the polystyrene solution to be added was set at 2% as a mass percent, and other solution preparation conditions and the projections pattern transfer step were the same as those of Example 3.

Following the same procedures as in Example 3, preparation and coating of metal microparticles were performed, and a projections pattern was transferred to a magnetic recording layer. Consequently, aggregates were formed on the medium because the polystyrene concentration was high, and a projections difference of a few ten nm was produced. These aggregates were larger than those of Comparative Example 1, and formed at random on a few-μm order in the medium plane. Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 3

Comparative Examples 3 to 5 are results when the noble-metal microparticle solution concentration and additive polymer solution concentration were fixed, and the molecular weight of the polymer was changed. The solution preparation conditions and the projections pattern transfer step were the same as those of Example 3. Note that this example is a result when the polystyrene molecular weight was 2,000.

Following the same procedures as in Example 3, preparation and coating of metal microparticles were performed, and a projections pattern was transferred to a magnetic recording layer. Consequently, aggregates were formed on the medium because the polystyrene concentration was high, and a projections difference of a few ten nm was produced. These aggregates were larger than those of Comparative Example 1, and formed at random on a few-μm order in the medium plane. Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 4

Comparative Example 4 is a result when the polystyrene molecular weight was 3,000, and other contents were the same as those of Comparative Example 3.

Following the same procedures as in Comparative Example 3, preparation and coating of metal microparticles were performed, and a projections pattern was transferred to a magnetic recording layer. Consequently, aggregates were formed on the medium because the polystyrene concentration was high, and a projections difference of a few ten nm was produced. These aggregates were larger than those of Comparative Example 1, and formed at random on a few-μm order in the medium plane. In addition, since the distance between the microparticles increased as the molecular weight increased, the interaction between the microparticles weakened, and the pattern pitch dispersion worsened. Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 5

Comparative Example 5 is a result when the polystyrene molecular weight was 11,000, and other contents were the same as those of Comparative Example 3.

Following the same procedures as in Comparative Example 3, preparation and coating of metal microparticles were performed, and a projections pattern was transferred to a magnetic recording layer. Consequently, aggregates were formed on the medium because the polystyrene concentration was high, and a projections difference of a few ten nm was produced. These aggregates were larger than those of Comparative Example 1, and formed at random on a few-μm order in the medium plane. In addition, the multilayered structure of the microparticles was much larger than that of Comparative Example 3 using low-molecular-weight polystyrene. Furthermore, since the distance between the microparticles increased as the molecular weight increased, the interaction between the microparticles weakened, and the pattern pitch dispersion worsened. Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 6

Comparative Example 6 is a result when Au having no base-metal covering was used, and other conditions were the same as those of Comparative Example 3.

Following the same procedures as in Comparative Example 3, preparation and coating of metal microparticles were performed, and a projections pattern was transferred to a mask layer and magnetic recording layer. When the projections pattern was transferred to the mask layer, the Au microparticles aggregated as shown in FIG. 19, and worsened the pattern uniformity. This is so because no covering layer was formed around the Au microparticles, so the Au microparticles readily aggregated because the protective group disappeared during etching.

Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 7

Comparative Examples 7 to 9 are results when polystyrene having no base-metal terminal end was used as the additive polymer, and the solution concentration was variously changed. Other conditions were the same as those of Comparative Example 3. Note that in this example, the second solvent was toluene, the polystyrene molecular weight was 2,000, and the second solvent concentration was 2% as a mass percent.

Following the same procedures as in Comparative Example 3, preparation and coating of metal microparticles were performed, and a projections pattern was transferred to a mask layer and magnetic recording layer. When the projections pattern was transferred to the mask layer, the Au microparticles aggregated and worsened the pattern uniformity as in Comparative Example 6.

Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 8

Comparative Example 8 is the same as Comparative Example 7 except that the second solvent concentration was 4%.

Following the same procedures as in Comparative Example 7, preparation and coating of metal microparticles were performed, and a projections pattern was transferred to a mask layer and magnetic recording layer. When the projections pattern was transferred to the mask layer, the Au microparticles aggregated and worsened the pattern uniformity as in Comparative Example 6. In addition, polystyrene tended to aggregate because the solution concentration was increased, and aggregates having a height of a few hundred nm were formed in the medium plane.

Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 9

Comparative Example 9 is the same as Comparative Example 7 except that the second solvent concentration was 6%.

Following the same procedures as in Comparative Example 7, preparation and coating of metal microparticles were performed, and a projections pattern was transferred to a mask layer and magnetic recording layer. When the projections pattern was transferred to the mask layer, the Au microparticles aggregated and worsened the pattern uniformity as in Comparative Example 6. In addition, polystyrene tended to aggregate because the solution concentration was increased, and aggregates having a height of a few hundred nm were formed in the medium plane.

Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 10

Comparative Examples 10 and 11 are examples in which the releasabilities of microparticles formed on substrates and etched were compared. Compared to the examples, only the second solvent was used and a polymer-containing solvent having no base-metal terminal end was used in these comparative examples.

In this example, only toluene was used as the second solvent, i.e., the release solution, and other conditions were the same as those of Comparative Example 3. Noble-metal microparticles were removed immediately after a projections pattern was formed on a transfer layer below the microparticles.

When only toluene was used as the release solvent as in this example, Au microparticles remained on the mask after etching, and could not easily be removed. Also, when forming the projections pattern on the mask layer, the aggregation of the microparticles was significant and largely worsened the transfer accuracy.

### Comparative Example 11

Comparative Example 11 is an example in which polystyrene having no base-metal terminal end was used as the release solvent, and other conditions were the same as those of Comparative Example 10. Note that in this example, the second solvent concentration was adjusted to 2% as a mass percent.

When using polystyrene having no base-metal terminal end as in this example, no polymer chain bonded to the etched microparticles, so the tendency of release was the same as that of Comparative Example 10, and it was not possible to remove the microparticles on the medium surface. Also, when forming the projections pattern on the mask layer, the aggregation of the microparticles was significant and largely worsened the transfer accuracy.

### Comparative Example 12

Comparative Examples 12 to 14 are results when the total roughness of the substrate/layer to be processed/mask layer was changed, and also show examples of the related art in which neither the base metal nor the polymer was added for comparison with the examples.

This example is a result when the total surface roughness of the mask was 0.5 nm, and other steps were the same as those of Comparative Example 6. The roughness was adjusted by changing the sputtering pressure when forming the mask layer. Note that the projections pattern transfer accuracy of a mask having an average surface roughness of 0.5 nm significantly deteriorated when compared to that of Example 26, so the processing margin of the projections roughness was unallowable. In addition, the microparticle layer aggregated, and the transferred pattern dimensional accuracy extremely deteriorated.

Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 13

Comparative Example 13 is a result when the total surface roughness of the mask was 0.6 nm, and other steps were the same as those of Comparative Example 12. As in Comparative Example 12, the roughness was adjusted by changing the sputtering pressure when forming the mask layer. Note that the projections pattern transfer accuracy of a mask having an average surface roughness of 0.6 nm was worse than that of Comparative Example 12, and the pitch dispersion worsened as the roughness increased. In addition, the microparticle layer aggregated, and the transferred pattern dimensional accuracy extremely deteriorated.

Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

### Comparative Example 14

Comparative Example 14 is a result when the total surface roughness of the mask was 0.7 nm, and other steps were the same as those of Comparative Example 12. As in Comparative Example 12, the roughness was adjusted by changing the sputtering pressure when forming the mask layer. Note that the projections pattern transfer accuracy of a mask having an average surface roughness of 0.7 nm was worse than that of Comparative Example 13. Especially in a portion where the distance between microparticles was narrow, many aggregates were formed due to the influence of the pitch variation resulting from the increase in roughness.

Also, a head floating amount with respect to the obtained magnetic recording medium was measured by a glide height tester, thereby evaluating the floating characteristic. Consequently, many hits were found on the medium surface, and it was not possible to pass a floating amount of 8 nm as a standard necessary to evaluate the read/write characteristic of the medium.

Tables 1 to 3 below collectively show the above-mentioned examples and comparative examples.

TABLE 1

| | | | | | | Second | Coating | Glide |
|---|---|---|---|---|---|---|---|---|
| | | Covering | | | | solvent | solution | evaluation |
| | Noble-metal | (base metal) | First | Second | Protective | concentration | concentration | 8-mm |
| Example | particles | material | solvent | solvent | group | [wt. %] | [wt. %] | floating |
| 1 | Au | S | Toluene | Toluene | SH-PS | 0.5 | 2.8 | — |
| 2 | Au | S | Toluene | Toluene | SH-PS | 0.5 | 2.8 | — |
| 3 | Au | S | Toluene | Toluene | SH-PS | 0.5 | 2.8 | Pass |
| 4 | Au | S | Toluene | Toluene | SH-PS | 1 | 2.8 | Pass |
| 5 | Au | S | Toluene | Toluene | SH-PS | 0.5 | 2.5 | Pass |
| 6 | Au | S | Toluene | Toluene | SH-PS | 0.5 | 3 | Pass |
| 7 | Au | S | Toluene | Toluene | SH-PS | 0.5 | 3.5 | Pass |
| 8 | Ag | S | Toluene | Toluene | SH-PS | 0.5 | 2.8 | Pass |
| 9 | Pt | S | Toluene | Toluene | SH-PS | 0.5 | 2.8 | Pass |
| 10 | Pd | Si | Toluene | Toluene | Si-PS | 0.5 | 2.8 | Pass |
| 11 | Ir | Cl | Toluene | Toluene | Cl-PS | 0.5 | 2.8 | Pass |
| 12 | Rh | S | Toluene | Toluene | SH-PS | 0.5 | 2.8 | Pass |
| 13 | Ru | Cl | Toluene | Toluene | Cl-PS | 0.5 | 2.8 | Pass |
| 14 | Au | S | Toluene | Hexane | SH-PS | 0.5 | 2.8 | Pass |

TABLE 2

| | | | | | | Second | Coating | Glide |
|---|---|---|---|---|---|---|---|---|
| | | Covering | | | | solvent | solution | evaluation |
| | Noble-metal | (base metal) | First | Second | Protective | concentration | concentration | 8-mm |
| Example | particles | material | solvent | solvent | group | [wt. %] | [wt. %] | floating |
| 15 | Au | S | Toluene | PGMEA | SH-PS | 0.5 | 2.8 | Pass |
| 16 | Au | S | Toluene | THF | SH-PS | 0.5 | 2.8 | Pass |
| 17 | Au | S | Toluene | Hexyl | SH-PS | 0.5 | 2.8 | Pass |
| | | | | acetate | | | | |
| 18 | Au | S | Toluene | Toluene | SH-MMA | 0.5 | 2.8 | Pass |
| 19 | Au | S | Toluene | Toluene | SH-BR | 0.5 | 2.8 | Pass |
| 20 | Au | S | Toluene | Toluene | SH-IR | 0.5 | 2.8 | Pass |
| 21 | Au | S | Toluene | Toluene | SH-PE | 0.5 | 2.8 | Pass |
| 22 | PtFe | S | Toluene | Hexane | SH-PS | 0.5 | 2.8 | Pass |
| 23 | IrPd | S | Toluene | Hexane | SH-PS | 0.5 | 2.8 | Pass |
| 24 | PdSi | S | Toluene | Hexane | SH-PS | 0.5 | 2.8 | Pass |
| 25 | Au | S | Toluene | Toluene | SH-PS | 0.5 | 2.8 | Pass |
| 26 | Au | S | Toluene | Toluene | SH-PS | 0.5 | 2.8 | Pass |
| 27 | Au | S | Toluene | Toluene | SH-PS | 0.5 | 2.8 | Pass |
| 28 | Au | S | Toluene | Toluene | SH-PS | 0.5 | 2.8 | Pass |

TABLE 3

| | | | | | | Second | Coating | Glide |
|---|---|---|---|---|---|---|---|---|
| | | Covering | | | | solvent | solution | evaluation |
| Comparative | Noble-metal | (base metal) | First | Second | Protective | concentration | concentration | 8-mm |
| Example | particles | material | solvent | solvent | group | [wt. %] | [wt. %] | floating |
| 1 | Au | S | Toluene | Toluene | SH-PS | 1.5 | 2.8 | Δ |
| 2 | Au | S | Toluene | Toluene | SH-PS | 2 | 2.8 | Δ |
| 3 | Au | S | Toluene | Toluene | SH-PS | 2 | 2.8 | Δ |
| 4 | Au | S | Toluene | Toluene | SH-PS | 2 | 2.8 | Δ |
| 5 | Au | S | Toluene | Toluene | SH-PS | 2 | 2.8 | Δ |
| 6 | Au | — | Toluene | — | — | 2 | 2.8 | Δ |
| 7 | Au | — | Toluene | Toluene | PS | 2 | 2.8 | Δ |
| 8 | Au | — | Toluene | Toluene | PS | 4 | 2.8 | Δ |
| 9 | Au | — | Toluene | Toluene | PS | 6 | 2.8 | Δ |
| 10 | — | — | — | Toluene | — | — | — | — |
| 11 | — | — | — | Toluene | PS | 2 | — | — |
| 12 | Au | — | Toluene | — | — | — | 2.8 | Δ |
| 13 | Au | — | Toluene | — | — | — | 2.8 | Δ |
| 14 | Au | — | Toluene | — | — | — | 2.8 | Δ |

In these tables, SH-PS indicates thiol-terminal-end polystyrene, Si-PS indicates siloxane-terminal-end polystyrene, Cl-PS indicates chloro-terminal-end polystyrene, SH-MMA indicates thiol-terminal-end methacrylate, SH-BR indicates thiol-terminal-end polybutadiene, SH-IR indicates a thiol-terminal-end polyisoprene, SH-PE indicates thiol-terminal-end polyethylene, and PS indicates polystyrene.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern formation method comprising:
forming a target layer to be processed on a substrate;
adding a second dispersion containing a polymer material including a polymer chain having a base metal at a terminal end and a second solvent to a first dispersion containing noble-metal microparticles and a first solvent, thereby preparing a noble-metal microparticle layer coating solution in which microparticles covered with the polymer material are dispersed;
arranging the noble-metal microparticles covered with the polymer material on the target layer by using the noble-metal microparticle layer coating solution, thereby forming a noble-metal microparticle layer; and
transferring a projections pattern based on the noble-metal microparticle layer to the target layer.

2. The method according to claim 1, further comprising removing the noble-metal microparticle layer, after the transferring the projections pattern based on the noble-metal microparticle layer to the target layer.

3. The method according to claim 1, wherein the noble-metal microparticle contains at least one element selected from the group consisting of gold, silver, platinum, ruthenium, palladium, and iridium.

4. The method according to claim 3, wherein the noble-metal microparticle has a core-shell structure including a core containing at least one element selected from the group consisting of gold, silver, platinum, ruthenium, palladium, and iridium, and a shell formed on the core and containing a base metal selected from the group consisting of carbon, silicon, aluminum, titanium, chromium, manganese, cobalt, nickel, copper, iron, zinc, zirconium, niobium, hafnium, tantalum, tungsten, bismuth, an amine compound, phosphorus, sulfur, fluorine, chlorine, bromine, and iodine.

5. The method according to claim 1, wherein the polymer material which is adsorbed to the noble-metal microparticle includes a functional group containing a base metal at least one terminal end of the polymer chain, and a functional group which affiliates with the second solvent at the other terminal end.

6. The method according to claim 1, wherein the polymer material includes a main chain selected from the group consisting of polyethylene, polystyrene, polymethacrylate, polybutadiene, polyisoprene, and polypropyrene.

7. A release method comprising:
preparing a second dispersion containing a polymer material including a polymer chain having a base metal at a terminal end and a second solvent; and
applying the second dispersion to noble-metal microparticles arranged on a target layer to be processed, covering surfaces of the noble-metal microparticles with the polymer material, and affiliating the polymer chain with the surfaces of the noble-metal microparticles, thereby releasing the noble-metal microparticles from the target layer.

8. The method according to claim 7, further comprising removing the noble-metal microparticle layer, after the transferring the projections pattern based on the noble-metal microparticle layer to the target layer.

9. The method according to claim 7, wherein the noble-metal microparticle contains at least one element selected from the group consisting of gold, silver, platinum, ruthenium, palladium, and iridium.

10. The method according to claim 9, wherein the noble-metal microparticle has a core-shell structure including a core containing at least one element selected from the group consisting of gold, silver, platinum, ruthenium, palladium, and iridium, and a shell formed on the core and containing a base metal selected from the group consisting of carbon, silicon, aluminum, titanium, chromium, manganese, cobalt, nickel, copper, iron, zinc, zirconium, niobium, hafnium, tantalum, tungsten, bismuth, an amine compound, phosphorus, sulfur, fluorine, chlorine, bromine, and iodine.

11. The method according to claim 7, wherein the polymer material which is adsorbed to the noble-metal microparticle includes a functional group containing a base metal at least one terminal end of the polymer chain, and a functional group which affiliates with the second solvent at the other terminal end.

12. The method according to claim 7, wherein the polymer material includes a main chain selected from the group consisting of polyethylene, polystyrene, polymethacrylate, polybutadiene, polyisoprene, and polypropyrene.

13. A magnetic recording medium manufacturing method comprising:
forming a magnetic recording layer on a substrate;
forming a mask layer on the magnetic recording layer;
adding a second dispersion containing a polymer material including a polymer chain having a base metal at a terminal end and a second solvent to a first dispersion containing noble-metal microparticles and a first solvent, thereby preparing a noble-metal microparticle layer coating solution in which the noble-metal microparticles covered with the polymer material are dispersed;
arranging the noble-metal microparticles covered with the polymer material on the mask layer by using the coating solution, thereby forming a noble-metal microparticle layer;
transferring a projections pattern based on the noble-metal microparticle layer to the mask layer; and
transferring the projections pattern to the magnetic recording layer.

14. The method according to claim 13, wherein the noble-metal microparticle contains at least one element selected from the group consisting of gold, silver, platinum, ruthenium, palladium, and iridium.

15. The method according to claim 14, wherein the noble-metal microparticle has a core-shell structure including a core containing at least one element selected from the group consisting of gold, silver, platinum, ruthenium, palladium, and iridium, and a shell formed on the core and containing a base metal selected from the group consisting of carbon, silicon, aluminum, titanium, chromium, manganese, cobalt, nickel, copper, iron, zinc, zirconium, niobium, hafnium, tantalum, tungsten, bismuth, an amine compound, phosphorus, sulfur, fluorine, chlorine, bromine, and iodine.

16. The method according to claim 13, wherein the polymer material includes a functional group which affiliates with the second solvent at the other terminal end of the polymer chain.

17. The method according to claim 13, wherein the polymer material includes a main chain selected from the group consisting of polyethylene, polystyrene, polymethacrylate, polybutadiene, polyisoprene, and polypropyrene.

18. The method according to claim 13, wherein when transferring the pattern of the noble-metal microparticle layer to the mask layer, processing is performed by dry etching using a gas containing fluorine.

19. The method according to claim 13, further comprising forming a transfer layer between the mask layer and the noble-metal microparticle layer.

20. A magnetic recording medium manufactured by a method cited in claim 13.

21. A stamper manufacturing method comprising:
adding a second dispersion containing a polymer material including a polymer chain having a base metal at a terminal end and a second solvent to a first dispersion containing noble-metal microparticles and a first solvent, thereby preparing a noble-metal microparticle layer coating solution in which microparticles covered with the polymer material are dispersed;
arranging the noble-metal microparticles covered with the polymer material on a substrate by using the coating solution, thereby forming a noble-metal microparticle layer;
forming a conductive layer along a projections pattern based on the noble-metal microparticle layer;
forming an electroformed layer by performing electroplating by using the conductive layer as an electrode;
releasing the electroformed layer from the substrate; and
removing a residue remaining on the electroformed layer.

22. The method according to claim 21, wherein the releasing the electroformed layer from the substrate comprises dipping the substrate and the electroformed layer in the second dispersion as a release solution, covering surfaces of the noble-metal microparticles between the substrate and the electroformed layer with the base metal, and affiliating the terminal-end polymer chain with the second dispersion, thereby releasing the electroformed layer from the substrate.

23. The method according to claim 21, further comprising:
forming a transfer layer on the substrate, before the forming the noble-metal microparticle layer; and
transferring the projections pattern based on the noble-metal microparticle layer to the transfer layer, and removing the noble-metal microparticle layer, before the forming the conductive layer.

24. The method according to claim 21, wherein the noble-metal microparticle contains at least one element selected from the group consisting of gold, silver, platinum, ruthenium, palladium, and iridium.

25. The method according to claim 24, wherein the noble-metal microparticle has a core-shell structure including a core containing at least one element selected from the group consisting of gold, silver, platinum, ruthenium, palladium, and iridium, and a shell formed on the core and containing a base metal selected from the group consisting of carbon, silicon, aluminum, titanium, chromium, manganese, cobalt, nickel, copper, iron, zinc, zirconium, niobium, hafnium, tantalum, tungsten, bismuth, an amine compound, phosphorus, sulfur, fluorine, chlorine, bromine, and iodine.

26. The method according to claim 21, wherein the polymer material includes a functional group which affiliates with the second solvent at the other terminal end of the polymer chain.

27. The method according to claim 21, wherein the polymer material includes a main chain selected from the group consisting of polyethylene, polystyrene, polymethacrylate, polybutadiene, polyisoprene, and polypropyrene.
